(19) United States
(12) Patent Application Publication
(10) Pub. No.: US 2013/0144807 A1
(43) Pub. Date: Jun. 6, 2013

(54) COMPUTERIZED SYSTEM AND METHOD FOR A STRUCTURED FINANCIAL PRODUCT

(71) Applicants: Marc Packles, New York, NY (US); Joseph Halpern, New York, NY (US)

(72) Inventors: Marc Packles, New York, NY (US); Joseph Halpern, New York, NY (US)

(21) Appl. No.: 13/571,180

(22) Filed: Aug. 9, 2012

Related U.S. Application Data
(60) Provisional application No. 61/522,607, filed on Aug. 11, 2011.

(51) Int. Cl. G06Q 40/06

(52) U.S. Cl. CPC G06Q 40/06
USPC 705/36 R

(57) ABSTRACT

A computerized method and system is disclosed for creating custom structured financial products as well as standardized exchange traded structured financial products. The structured financial products include a fixed fund component and a derivative component. The fixed fund component is linked to an underlying asset. In addition, the risk profile of the derivative component is matched to the investor selected risk profile of the fixed fund component in order to provide the investor with a selectable level of risk.

### CROSS REFERENCE TO RELATED APPLICATIONS

This application claims priority to and the benefit of U.S. Patent Application No. 61/522,607, filed on Aug. 11, 2011, hereby incorporated by reference.

### FIELD OF THE INVENTION

The present invention relates to a computerized method and system for enabling an investor, securities broker or other individual or entity (individually or collectively “investor”) to create a customized structured financial product or to invest in a standardized structured financial product. The structured financial products are created by combining a fund comprised of a portfolio of assets (the “Fund Component” or “Fund”), with a derivative that is competitively priced in a transparent process (the “Derivative Component” or “Derivative Strategy” or “Asset-Linked Product”) that will be listed and traded on a securities exchange in the manner described below. The Fund Component is unique because in addition to greatly enhancing investor flexibility by allowing for real control of risk allocation, the Funds will be diversified portfolios, based on index definitions for each Fund, further minimizing default risk relative to the issuing banks. So, for example, a Fund consisting of a portfolio of financial companies is theoretically less risky than a single investment in one bank. Asset-Linked Products will have the ability to be linked to any of the Funds.

The invention, described in more detail below, is a unique financial product that gives investors flexibility to customize a structured product while also managing their risks and exposures. In addition, the invention provides more flexibility, allows investors to diversify their portfolio, hedge risks and gives investors flexibility to choose the assets in the Fund Component of the structured product, as well as customize the Derivative Component to enable investors to create unique structured products based on numerous investment criteria. The Derivative Component is competitively priced by a consortium of competitive liquidity providers to provide exchange based structured financial products that are manufactured differently from other structured financial products in the industry.

### BACKGROUND OF THE INVENTION

Structured products are one of the most innovative and successful financial products introduced over the last twenty five years. By offering a wide array of features and flexibility, structured products provide a more attractive and customizable risk/reward profile than most financial instruments available in the marketplace. This is accomplished by offering defined levels of risk, return, and maturity in an asset linked note. As a result of this customization, along with other favorable characteristics, the structured products industry enjoys success around the world with over $1 trillion in assets under management “AUM” in Europe alone and $250 billion in the United States as of 2010, according to StructuredRetailProducts.com.

Currently, the industry is dominated by a small group of large investment banks accounting for a majority of issuance and capturing sizable profits along the way. These banks issue their own subordinated debt which is then linked to a derivative typically priced by its internal trading desk, thus creating a structured product that is unique to that particular bank. The sales team then distributes the structured product, primarily utilizing the banks retail network.

It is understood a structured product is typically a note with an embedded derivative strategy. The current process of creating a structured product is typically as follows: The issuer's treasury department will set a yield in which it is willing to issue a note to the public. The issuer's trading desk will then embed a strategy that consists of at least one derivative position into the note. The newly created structured product is then preferably marketed and sold, primarily through the issuer's wealth management and sales division. In the United States, a small component of these structured products are listed on an exchange, however, the vast majority are issued in the over-the-counter market (“OTC”).

It is to be understood and appreciated that due to the present industry wide process of constructing a structured product coupled with the lack of competition in the American marketplace, a number of significant issues affect the industry resulting in an inefficient market place, costing the investor materially.

For instance, some noted drawbacks of the process of constructing a structured product, which create such an inefficient marketplace, are as follows:

One, a lack of price competition due partly to the bespoke characteristic of the product, generally narrow distribution, and OTC nature of the industry. Structured products are extremely customizable, allowing for numerous permutations. As a result, it is rare for two banks to issue an identical structured product simultaneously. Given the complexity of a structured product, even on the rare occasion that similar structured products are issued in a short time period by competing issuers, it is very difficult for the average investor to fully appreciate any price discrepancies that might exist between the two products or make an educated decision of which structured product is a better value.

In view of the above and coupled with the fact that the vast majority of structured products are issued in an OTC environment and primarily via a narrow distribution through the wealth management division of the issuer, these products suffer from a lack of transparency (as discussed in further detail below). The trading and sales teams of the issuers generally take advantage of this lack of transparency, the lack of direct competition on an issued product, and the practice of primarily distributing through internal divisions by setting wide, non competitive spreads and tacking on high fees when pricing a structured product. Given the success of the structured products industry and the high profit margins built into the process, there is little incentive for any of the participants in the industry to price structured products competitively.

Further, investors generally request a specific structure from the banks, as opposed to banks creating the structures and marketing those structures through their wealth management division to investors. Although in recent years, there has been an increased level of price competition in this segment of the industry, there is still inefficiency in price competition for two primary reasons. First, there is no central exchange allowing the investor to simultaneously request quotes from all the participants in the industry. That is, an investor needs to have an account and the correct contacts at each bank in which a quote is requested or, at the least, access through an intermediary on the client's behalf. Second, each bank issues its own note component of the structured product resulting in products that are not identical. Hence, this enables banks with lower credit ratings to price their debt component of the structured product at wider spreads and still appear to be competitive from an investor's viewpoint.

Two, the lack of price competition, low transparency and complexity of a structured product results in a lack of liquidity. Frontloaded fees and OTC issuance are additional industry practices that result in illiquid secondary markets. To this point, of the structured products issued in 2010 that are tracked by Trace, the bond price reporting system of the Financial Industry Regulatory Authority (“FINRA”), 35% were never traded after issuance and 18% had trading activity on only one day during the term of the structured product offering. Current industry practice is to embed expensive, frontloaded fees, an issue to be discussed below, into the structured product. Therefore, a structured product issued at par with a 2% fee has a real value of 98% immediately after issuance. It is in the issuing bank's best interest to hide this immediate loss of value. This is partly done by offering wide, illiquid secondary markets. Issuance of the structured product comprised of a bank issued note and a derivative strategy generally takes place in the OTC market. If an investor wants to trade out of a position, the only way to fully remove the associated counterparty risk is to trade directly with the issuing bank. Competing banks are very hesitant to make markets in bank notes other than their own. The issuer understands this and therefore has no incentive to offer a liquid, competitive quote.

Three, it is to be further understood and appreciated the vast majority of notes issued are senior unsecured obligations, resulting in concentrated counterparty risk. Investors have issuing bank's counterparty risk on both the note component and the derivative component of the structured product. For example, this issue came to the forefront shortly after the bankruptcy of Lehman Brothers when billions of dollars of structured products issued by Lehman Brothers dropped precipitously in value, shocking its holders. Most investors do not have a true understanding of the counterparty risk they hold.

Four, another noted drawback is that the inconsistency of structured product offerings, low levels of competition and the fact that the product is traded OTC with no real secondary market all conspire to create an environment of very low transparency. Add to this the fact that there is no industry wide standard for methodology or nomenclature and minimal educational literature despite the relative complexity of the underlying product. This lack of transparency often results in hidden fees and confusing products and payouts, leading to frustrated investors and, from time to time, lawsuits.

Five, low levels of competition allow issuers the ability to charge high fees relative to the assets relating to a structured product. According to the publication, Bloomberg Brief Structured Notes, banks charged an average of 1.6% on three month reverse convertibles issued in 2010. This translates to a 6.4% annualized rate. It is noted, the fee only represents what is disclosed in the registration statement for the structured product. This is a fee typically paid to the distributor. In addition to the stated fee, there is an unstated fee taken by the various departments of the issuer of the structured product. It is understood the total fees for three month reverse convertibles are probably closer to the range of 7%-10% on an annualized basis. On an annualized basis, fees tend to decline from this high mark for structured products with a longer duration, although they still remain expensive compared to other products in the market.

Six, it is to be understood the industry standard is currently to frontload all fees. It is to be appreciated this process would be difficult to modify given the many groups within the issuing bank that share in the fees. For instance, the trading team and the sales team of the issuing bank each take a fee before passing the structured product to the distributor where additional fees are assessed. Thus, issuing banks often have large infrastructures resulting in portions of their fees going to other areas, such as legal and risk management, resulting in higher upfront costs.

Seven, another noted drawback is that issuing banks primarily distribute structured products through their own retail networks. Over the last few years, a small group of boutique brokerage companies, such as Incapital and Advisors Asset Management have become wholesale distributors for some of the large issuing banks. This has not resulted in any material industry shift, with fees earmarked for internal brokers simply transferred to the independent distributors. Distribution remains purposely limited in its reach making it very difficult for an investor to have an accurate picture of what is available in the marketplace at any given time.

Eight, a further drawback of the industry is a relative lack of consistent offerings. Bank sales teams tend to chase new trends and adjust offerings based on market factors that affect the value of structured products. This negatively affects the investor base as it becomes difficult to track and become comfortable with a specific trading strategy. It also becomes difficult for investors to roll their positions forward upon expiration of a structured product as the bank might not offer that identical trading opportunity at that time. Furthermore, client confusion is rampant as new products in an already complex area of the market are constantly introduced and pitched to the investor.

Nine, there are also inconsistencies among and within United States issuers in regards to methodology and naming conventions. It is to be appreciated and understood, there has recently been a push by the European Structured Investment Products Association to define categories and develop nomenclature in an effort to solve consistency issues in the structured products industry, which has been met with minimal success. It is noted there has been no known similar movement in the United States as issuing banks market products individually rather than from a shared market standpoint. As a result, products with the same defining characteristics have multiple names used by the different issuing banks. Further exacerbating the situation and adding to the frustration of the client, are the inconsistencies in structural features of the product. For example, two separate issuing banks may offer 10% downside protection in their products, but one may allow for 100% downside risk by raising the downside participation below the 10% downside protection level, while the other might maintain the participation rate at a 1:1 ratio resulting in the risk of losing only 90% of one's principal.

Thus, in conclusion, it is evident, when reviewing the issues above, how the average investor can be confused. While the payout of a structured product upon maturity is fairly straightforward, current marketing in the industry tends to be ambiguous in its definitions, resulting in an unclear and imprecise picture of these payoffs. There is no uniform attempt to educate the investor and little if any marketing of the beneficial qualities of any particular structured product. Factor in the lack of transparency and inconsistency in issuance, methodology and nomenclature, and it is easy to see how investors can easily become frustrated and confused with structured products. As a result, the industry has dealt with a decent amount of negative publicity and lawsuits that have arisen due to both irresponsible selling by brokers and lack of transparency on the part of the issuing banks.

### SUMMARY OF THE INVENTION

It is an object of the present invention to overcome the noted drawbacks plaguing the structured product market.

In accordance with an illustrated embodiment of the present invention, a computerized method and system allows an investor to access a structured financial product portal and create and invest in a custom financial structured product (defined below as “Exchange Traded Security Request for Quote” or “ETS RFQ”) or invest in a standardized structured financial product (defined below as “Exchange Traded Security” or “ETS”). Each of the ETS Products, as defined below, includes a portfolio of assets (“Fund Component”) managed by the structured product system of the present invention, and a derivative component (“Derivative Component”) that investors may customize and is competitively priced by a consortium of liquidity providers. ETS Products are listed and traded on a national exchange and are cleared and settled through an entity registered with the Securities and Exchange Commission as a clearing agency under Section 17A of the Securities Exchange Act of 1934 (all such persons collectively referred to herein as “Exchange”).

Within this framework, the present invention allows for a number of initiatives, including but not limited to, the creation of (1) a structured financial product where an investor can create a bespoke or customized structured product (hereinafter “ETS Request for Quote” or “ETS RFQ”); (2) a platform where third parties, such as wealth management firms or distributors can create their own label of structured product thru an ETS alliance program (hereinafter as “ETS Alliance Program” or “ETS AP”); and (3) an ETS exchange traded fund product allows investors to maintain a particular strategy by the automated continual investing in an index of underlying structured product securities (defined hereinafter as “ETS Exchange Traded Fund” or “ETS ETF”) (ETS, ETS RFQ, ETS AP and ETS ETF, individually and collectively, are referred to as“ETS Product,” structured product” or “structured financial product”).

The Fund Component is a large source of differentiation for the present invention, as it is simply not a single bank note, but rather is a fixed income fund with specific characteristics unique to the ETS Products. The note component of the structured product, which has been a static component in the structured product industry, now becomes a dynamic Fund Component of the ETS Products.

Currently, the majority of structured products in the market consist of bank issued notes. The remaining are typically CDs. Banks issue their own structured notes resulting in concentrated counterparty risk assumed by the investor, incurring significant risk (i.e., Lehman Brothers bankruptcy). Investors compound their counterparty risk by having the same counterparty risk on the derivative component. If the bank defaults on the bond component of the note, it will most likely also default on the derivative component.

Furthermore, the investor is attracted to a specific structured product based on a derivative strategy, with the note component being secondary. There is currently little choice in the process. If the investor wants a specific leveraged structured product and has access to a similar leveraged product being issued by Morgan Stanley, for example, the investor has no choice but to take on the full credit risk of Morgan Stanley. If the investor has the capital to request a customized structure from a few banks or through a distributor, the investor will generally only have the ability to choose a bank and its respective credit risk. However, beyond this limited choice, there are no real options in the marketplace. Ironically, the investor has options in controlling the risk profile in the underlying derivative, but has little control of the risk associated with the note component, the component that typically makes up the majority of the initial value.

The present invention allows investors to match their individual risk profiles to the strategy dictating the Derivative Component and to the Fund Component, creating a level of flexibility and customization unparalleled in any market. Derivative Components can be linked to various types of assets, including but not limited to, equities, commodities, foreign exchange, and interest rate products, and the Derivative Components can be combined with any of the present invention funds (“Funds”).

The Fund Component of the ETS Products will be diversified based on rules specific for each Fund. The Funds will vary in risk, and may consist of assets from a broad range of issuers, including government agencies, investment grade companies or financial companies. A Fund consisting of a portfolio of financial companies is theoretically less risky than a single investment in one bank, further minimizing default risk relative to the issuing banks. Options are numerous, limited only to the extent of what Funds the present invention chooses to create.

The present invention approach is more favorable and less risky with no expected effect on the potential yield of the investor. This differentiation results in material benefits to the investor including increased flexibility and customization, allowing for a better match of the investor's risk/reward profile while minimizing counterparty risk through the use of a Fund Component comprised of a diversified portfolio of assets.

There are two distinct differences between the present invention Funds and a typical fixed income fund. First, each of the present invention Funds will need to manage its duration based on the maturities of the ETS Products. Second, the present invention will aim to provide a specific rate of return for the Fund Component embedded in each ETS Product issued, unless an actual default in the assets held by the Fund occurs. Furthermore, as AUM is increased, the present invention plans to evolve the asset accumulation procedure of the Funds to a direct issuance program (“ETS ISS”) whereby certain issuers (“Issuance Partners”) will raise capital through an agreement with the Funds. Ultimately, the Funds will consist of a portfolio of assets that are issued by the Issuance Partners that are specifically tailored to mature on the maturity date of the ETS Product itself.

Initially, the present invention Funds Component will consist of Funds comprised of assets issued by government entities, high grade companies and financial institutions. The present invention will provide two curves for each Fund, incorporating spread and liquidity risk. The curves will show the relation between the level of yield of the Fund and the time to maturity. One curve will represent the bid and the other will represent the offer. These curves will be updated continuously to determine the price of the Fund Component for a specific ETS Product.

The difficulty of exactly matching the Fund Component with the expiration of the ETS Product will be mitigated by the large and diverse assets available for inclusion in the respective Funds. The Fund's portfolio manager, using the ETS Fund Management System (“ETS FMS”), described below, will take into account any perceived liquidity constraints within the Fund through the use of both cash management techniques and a bank credit line. The present invention will compete favorably on price when compared to prices offered by the current issuers of structured products. The unique characteristics of the Fund Component, such as portfolio diversification and product choice, also make the present invention more advantageous than the structured products currently offered in the market.

As AUM grows, the present invention will approach potential issuers for inclusion in the present invention ETS ISS program. In 2010, Barclays raised roughly 60% ($34 billion) of total funding needs ($57 billion) from structured product issuance, primarily in the US market¹. Simply stated, structured products are an efficient and cheap mechanism to raise capital. The present invention, ETS ISS program, will allow the Fund Component to consist of assets that mature on the same maturity date as the ETS Product. This will result in superior, more competitive pricing for investors while simultaneously reducing risk in the ETS product. ¹Sarfraz Thind, “Structured Notes Biggest 2010 Funding Source For Barclays”, Bloomberg Brief Structured Notes, Feb. 17, 2011, P2

The present invention, ISS program, will also allow for more specific, credit based themes, increasing investor choice. As long as a minimum number of Issuance Partners join ISS Program a new Fund can theoretically be created. For example, a high grade industrial fixed income Fund can be created. Furthermore, investors or third party institutions who create their own bespoke ETS Product on behalf of a client or to market to an investor base will have the ability to create their own Fund or combine Funds to customize the Fund Component.

The users of the present invention will be able to align their risk profile by using an offered present invention Fund. All Funds consist of a portfolio of assets from various issuers, thus ensuring diversification within the Fund Component of each ETS Product. Pricing should remain competitive, even superior to the current product in the market, while providing investors with dynamic, flexible and less risky investments.

Currently, banks typically price the derivative component of their structured notes via their trading desks. Thus, there is no perceived competition on price and the trading desk typically has advanced knowledge of the planned distribution of the structured product, creating a non-competitive, and therefore, more expensive offer for the structured product, effectively adding a significant hidden fee.

It is an objective of the present invention system to use a number of liquidity providers to create a competitive and efficient auction process for pricing the Derivative Component of each ETS Product, which should result in materially tighter and more liquid spreads. This spread is reflected on the exchange through the bid and offer, making the costs of entering into a trade transparent. Thus, the present invention system significantly reduces costs and materially increases transparency.

Hence, the present invention system enables liquidity providers to benefit from new products to trade as well as a new source of trading revenue and provides benefits to investors from strong competitive quotes resulting in lower fees and a more competitive product. It is noted, automation and the reality of the current derivative exchanges competing for business have materially decreased spreads and margins in the listed options market making business. Additionally, the OTC market in general is traded predominantly by the investment banks and structured products are no exceptions, resulting in exchange based liquidity providers generally being locked out of the OTC market.

The present invention system uses the major liquidity providers to competitively price the Derivative Component of the structured product. This role blends seamlessly with their current activities in the listed options market, and will result in a significant new revenue source. It is to be appreciated that liquidity providers are better positioned than the banks to hedge structured products given their role as a market maker and liquidity provider, and their unparalleled access to markets. For instance, in accordance with the illustrated embodiment of the present invention, a primary liquidity provider is assigned to each ETS listing to ensure liquidity. In exchange for taking on this added responsibility, primary liquidity providers, including, for example, a Designated Market Maker (“DMM”) on the New York Stock Exchange NYSE and a Designated Primary Market Maker (“DPM”) on the Chicago Board Options Exchange (“CBOE”), are allocated a larger share of each trade wherein DMM and DPM designations on active products are considered valuable assets.

In an effort to further reduce costs, a creation/redemption process will be utilized for the present invention products. Liquidity providers will be able to break apart the Fund Component portion of a structured product through the creation/redemption process discussed below, and hedge the Derivative Component. By not incurring the risk of the Fund Component, the liquidity providers should be able to pass savings in terms of hedging costs and financing fees to the investor in the form of tighter spreads and/or higher potential payouts. Furthermore, the present invention introduces a unique characteristic in the creation/redemption process whereby a Derivative Component will be exchanged within the process (note illustrations of FIG. 17). In addition to compartmentalizing the risks in an efficient manner the present invention system will manage the Fund Component while liquidity providers will take on the risk of the Derivative Component. The addition of the derivative component should allow liquidity providers to lower their own financing costs by exhibiting offsetting positions from a risk perspective to respective clearing firms. Generally, liquidity providers have risk based haircuts. This will allow further cost savings that can be passed on to the investor.

An exemplary benefit provided by the present invention system is that the presence of numerous liquidity providers that will result in a more liquid and competitive market for the present invention structured product than is currently being offered in the marketplace.

Furthermore, the derivative exchanges all have electronic access due to large IT infrastructure development. This is an area where the liquidity providers are advanced relative to banks. Thus, in addition to the increased competition, which will allow for tighter, more liquid spreads, the efficient automated process of the present invention system allows for continuous markets in higher volume products.

It is to be understood and appreciated that by sourcing the Derivative Component of the ETS Product directly from the top liquidity providers in a competitive, transparent process based on a listed derivatives exchange, the present invention system offers a superior structured product relative to the current offerings in the market. The present invention system dramatically reduces costs, materially increases transparency and mitigates counterparty risk through clearance of the Derivative Component of the ETS Product and through diversification in the Fund Component. Further, an investor benefits from the present invention system through continuous competitive and liquid markets with consistent issuance and cleared Derivative Component. Currently, due to the large upfront fees, a lack of a liquid secondary market, and the OTC nature of the industry, it is costly to exit a position in a structured product prior to its maturity date. The present invention system provides a low accretive fee structure allowing for easy, low cost entry into and exit from structured product positions allowing for a robust secondary market. Fees for the present invention structured product are charged primarily through an annualized expense that accretes daily and is significantly lower than the current fee structure in the market. For example, instead of being charged, as an example, a 5% upfront service fee for a 1 year structured product, the current invention will assess an annualized fee of 1%, a much lower fee, and only assess the fee on a daily basis so long as the investor still holds the investment in the structured product (i.e., fees are assessed on the AUM of the structured product). Essentially, a daily fee of 1% divided by 365 or 0.0027% will be charged daily on the AUM.

It is noted that yet another issue hampering an investor's ability to more actively trade structured products is the OTC nature of the structured products whereby the lack of an established clearance process for such products forces the investor to seek out the original counterparty in exiting a position prior to maturity. Thus, in addition to the counterparty risk inherent in the trade, the lack of clearance process results in low incentives for the counterparty to provide a competitive price. The present invention system solves these issues through an exchange based clearance process which allows the investor to exit a position with any approved liquidity providers or any other investor or trader. Thus, some benefits to an investor are (1) competitive, liquid markets; (2) continuous, automated quotes; (3) a robust secondary market; (4) a consistent issuance calendar such as offering standard ETS with maturities of every third Friday of the month, matching the listed options market maturities; and (5) exchange based clearance and settlement, all of which reduce risk while increasing liquidity.

With regards to a distribution strategy for structured products, the present invention system takes advantage of three distinct, favorable trends in the development of its distribution strategy. The rise of the Registered Investment Advisor (“RIA”), migration towards open platforms by the large brokers and recent regulatory pressures are all beneficial to structured products. Financial institutions now sell or market financial products originated by other firms, whereas in the past they only sold financial products originated by their own financial institution. These trends have resulted in a focus by advisors and investors on low cost, highly transparent products with strong educational material, all major strengths of the structured product. From a distribution perspective, a structured product designed in accordance with the present invention is positioned similar to Exchange Traded Funds (“ETFs”). It is noted that ETFs are the low cost, highly liquid and more transparent version of mutual funds. In accordance with the present invention, structured products will become the low cost, highly liquid and significantly more transparent version of the current structured products.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 illustrates an exemplary computer system for use with the present invention.

FIGS. 2-20 illustrate various illustrative embodiments of the structured financial product that can be created by the computer system illustrated in FIG. 1.

FIG. 21 illustrates an exemplary web page available at a structured financial product portal in accordance with the present invention.

FIG. 22 is a work flow diagram of the computerized system in accordance with the present invention.

FIGS. 23-28 are exemplary software flow charts for implementing the present invention.

FIG. 29 illustrates sample records of various individual customized structured financial products in accordance with the present invention offered through the ETS Alliance Program.

FIG. 30 is an exemplary web page illustrating various customized standardized structured financial products listed on national exchanges with liquid markets.

### WRITTEN DESCRIPTION OF THE INVENTION

The present invention relates to a computerized method and system for enabling an investor to create and invest in a customized structured financial product as well as invest in standardized structured financial products that are traded on a securities exchange. These structured financial products include a Fund Component and a Derivative Component, both of which are unique and together create a financial product that is not currently available in the marketplace. The computerized system includes a web portal that enables an investor to select various features of the structured product, such as investment strategy, a Fund, the protection type, the protection amount, the price and the maturity. Based upon the investor's choices, the computerized system automatically prices the Fund Component and sends a request for a quote for the Derivative Component to a number of liquidity providers to obtain competitive pricing. The best quote from the liquidity providers for the Derivative Component is added to the price of the Fund Component in order to arrive at the overall price of the structured financial product. Alternatively, the investor may set the dollar amount of the Derivative Component, in such case, the liquidity providers will then solve for another variable of the Derivative Component, such as upside cap or downside protection level. For example, if an ETS RFQ is being sold for $100 par, and it is determined that the Derivative Component is $4 USD, then for the given set of inputs provided by the investor, the liquidity providers will solve for the only unknown variable, such as upside cap.

The Fund Component of the structured product is comprised of various assets, such as fixed income securities, from multiple issuers, thus limiting counterparty risk. In addition, the investor establishes a unique risk profile by selecting a Derivative Component which will also have a maturity that matches the maturity of the Fund Component, allowing the investor to customize its overall risk profile.

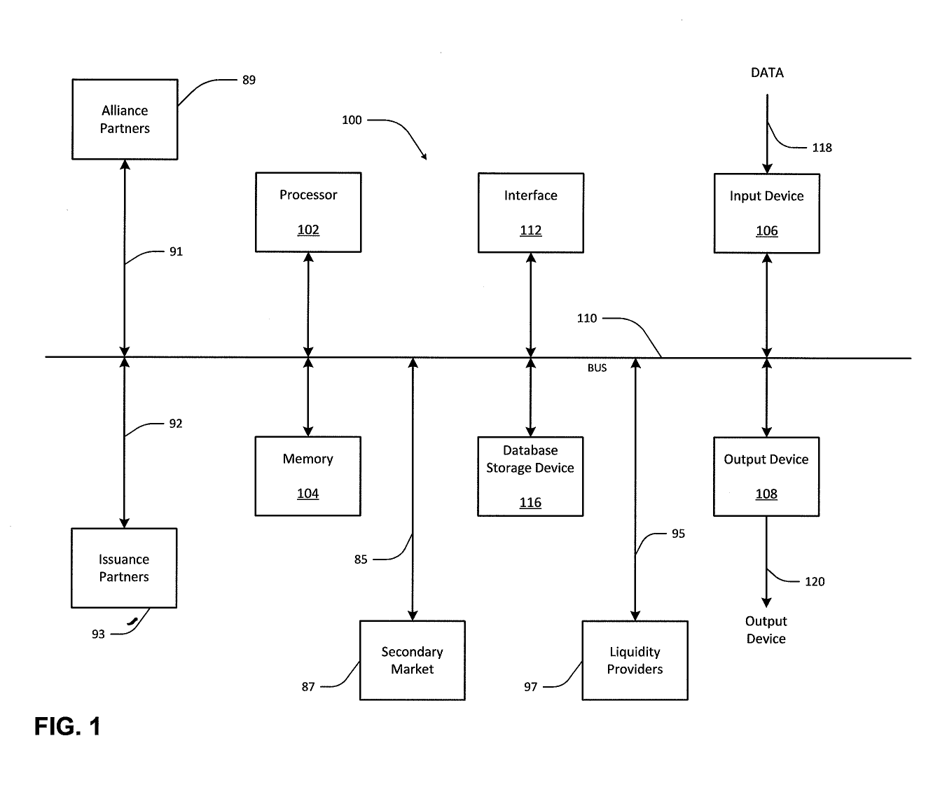

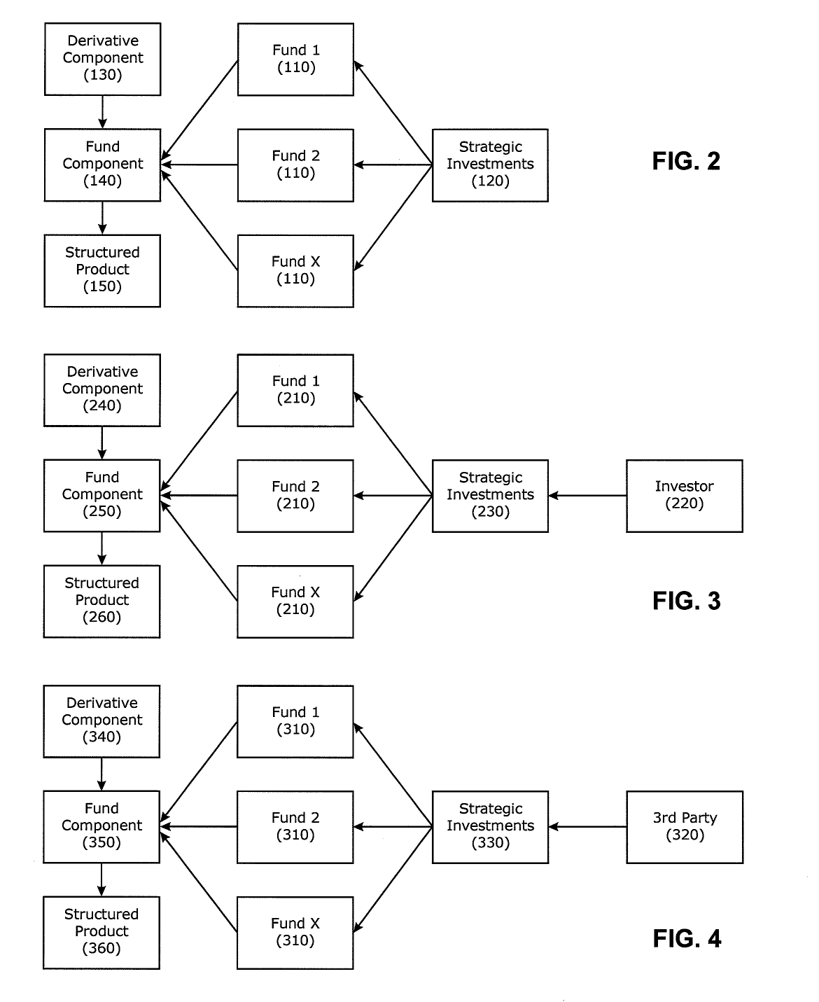

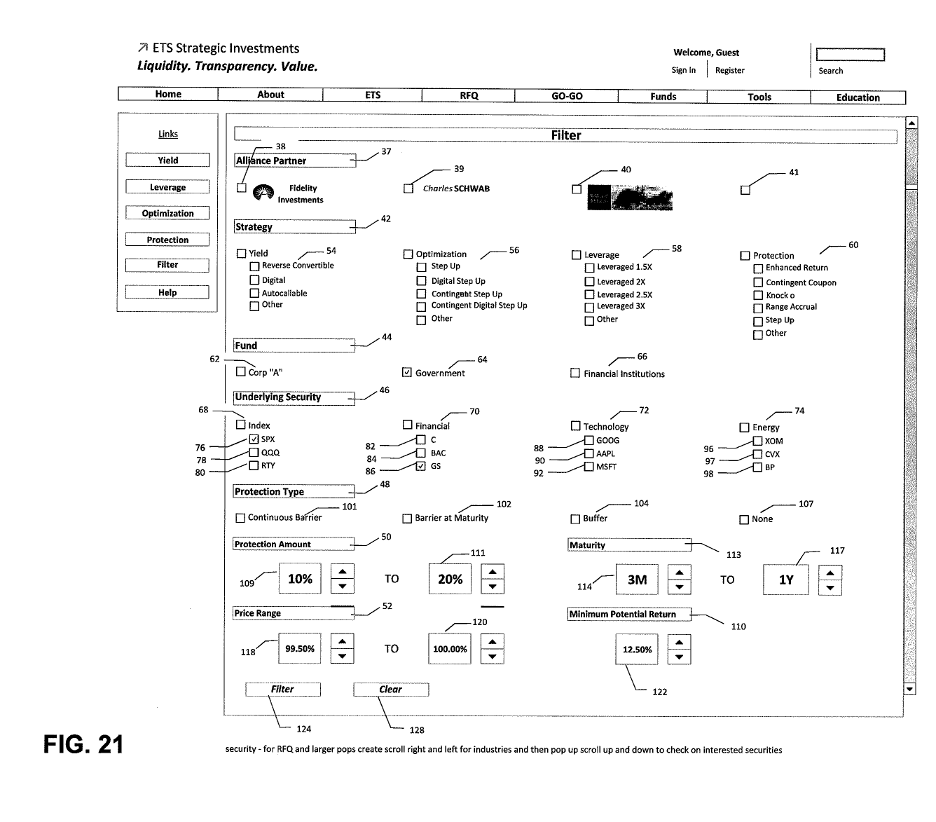

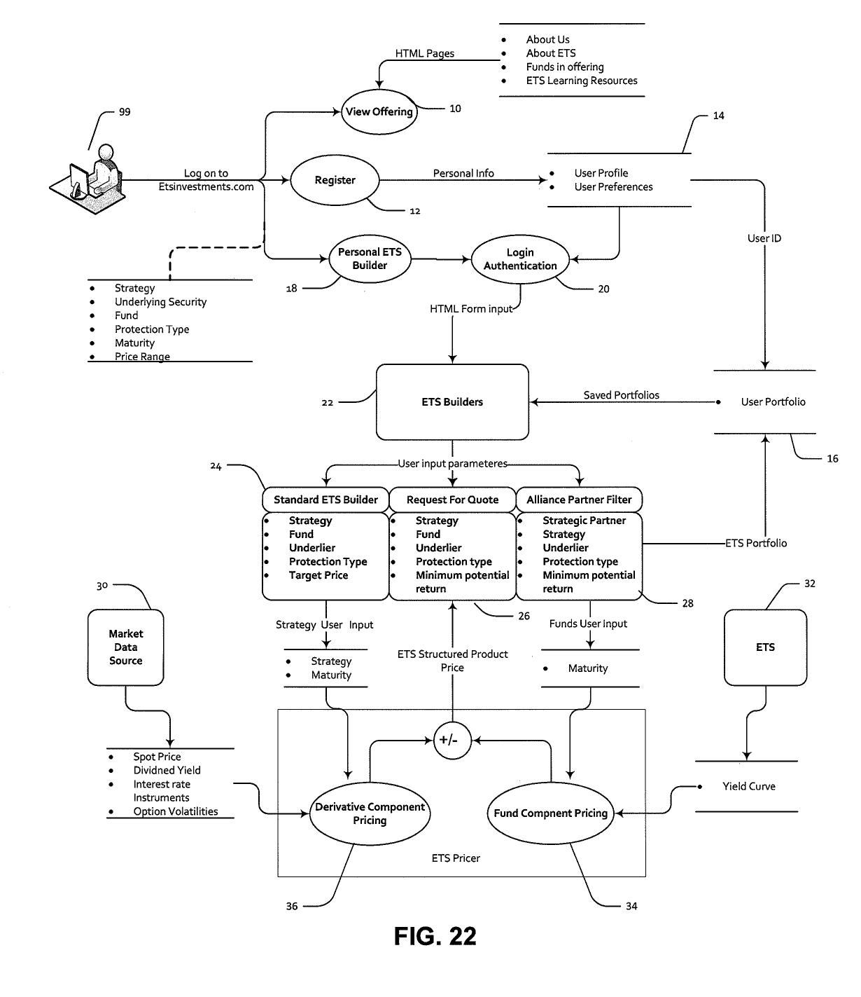

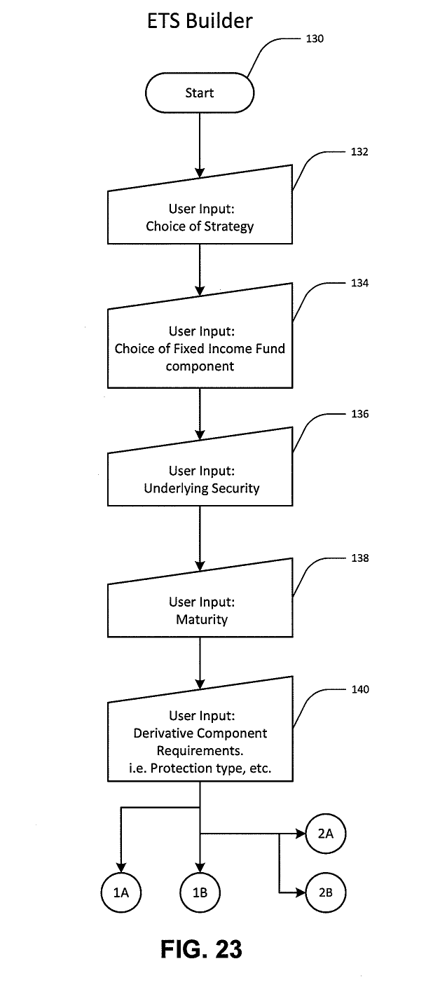

FIG. 1 illustrates an exemplary computer system for use with the present invention. FIG. 22 illustrates an exemplary work flow diagram for the computer system illustrated in FIG. 1. FIGS. 23-28 illustrate exemplary software flow diagrams for the computer system illustrated in FIG. 1. FIGS. 21, 29 and 30 illustrate exemplary web pages available at the structured financial product web portal in accordance with the present invention. FIGS. 2-20 illustrate various exemplary embodiments of methods and processes of the present invention that can be implemented on the computer system illustrated in FIG. 1.

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

It is to be appreciated that the various embodiments of the structured financial products in accordance with the invention as illustrated in FIGS. 2-20 and discussed below can be created using the computer system 100 programmed with software represented by the flow charts 2-28 and also include a conventional web host for creating the web portal and creating the exemplary web pages illustrated in FIGS. 21, 29 and 30.

### Computerized System and Method

Turning now descriptively to the drawings, in which similar reference characters denote similar elements throughout the several views, FIG. 1 depicts an exemplary general-purpose computing system in which illustrated embodiments of the present invention may be implemented.

The system and method are implemented by way of a computer system 100 that generally comprises at least one processor 102, or processing unit or a plurality of processors, a memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 116, which houses at least one database 116, can also be provided. The memory 104 can be any form of memory device, for example, volatile or non-volatile memory, solid state storage devices, magnetic devices, etc. The processor 102 could comprise more than one distinct processing device, for example to handle different functions within the processing system 100. Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example, a visual display on a monitor in conjunction with data transmitted to a network. A user could view data output, or an interpretation of the data output, on, for example, a monitor or using a printer. The storage device 116 can be any form of data or information storage means, for example, volatile or non-volatile memory, solid state storage devices, or magnetic devices.

In use, the computer system 100 is adapted to allow data or information to be stored in and/or retrieved from, via wired or wireless communication means, at least one database 116. The interface 112 may allow wired and/or wireless communication between the processing unit 102 and peripheral components that may serve a specialized purpose. Preferably, the processor 102 receives instructions as input data 118 via input device 106 and can display processed results or other output to a user by utilizing output device 108. More than one input device 106 and/or output device 108 can be provided. It should be appreciated that the processing system 100 may be any form of terminal, server, specialized hardware, or the like.

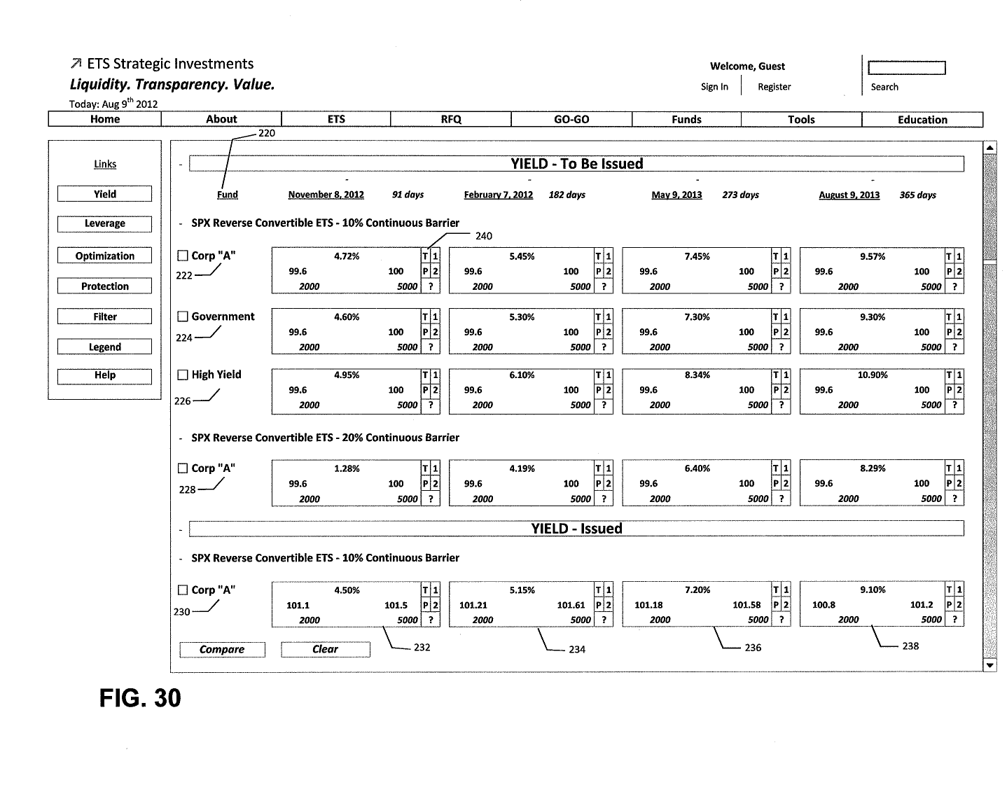

The computer system 100, illustrated in FIG. 1, may be used to create a custom structured financial product or standardized structured financial products, for example, as illustrated in FIG. 30, to be sold on an exchange. As mentioned above, the computerized system allows an investor to create a custom structured financial product by selecting various parameters regarding the structured financial product, as discussed above. Input from an investor interested in creating a custom structured financial product or investing in a standard structured financial product may input data 118 to the general computer system 100 by way of the input device 106 to create a custom structured financial product. The input device 106, may include various input devices, for example, a smart phone, laptop computer or tablet computer (not shown) that is Internet enabled. Access to the general computer system 100 may be by way of one or more wired or wireless bidirectional communication links coupled to the bus 110. In embodiments which include a web based portal, the communication may be over the Internet or Intranet.

As will be discussed in more detail below, the computer system 100 communicates with the primary market or Issuance Partners 93 by way of a communication link 92. The computer system 100 may request and receive market data from the secondary market 87 electronically by way of a bidirectional communication line 85. In addition, the computer system 100 automatically sends a request for a quote for the Derivative Component with the selected risk component to a consortium of liquidity providers, generally identified with the reference numeral 97, in order to obtain competitive pricing. The best quote from the liquidity providers 97 is aggregated with the Fund Component pricing to provide an overall price for the structured product to the investor 99. As such, a bidirectional communication links with the reference numeral 95. The bidirectional communication link 95 may be wired or wireless and communication may be over the Internet or Intranet. As will be discussed in more detail below, investors, including but not limited to Alliance Partners 89, may trade standard structured financial products on exchanges as well as co-branded or self-branded customized Alliance Partner products. These investors, including the Alliance Partners 89, may be connected to the general computer 100 by way of a bidirectional computer link 91.

It is to be appreciated that the processing system 100 may be a part of a networked communications system. Processing system 100 could connect to a network, for example the Internet or a WAN. Input data 118 and output data 120 could be communicated to other devices via a network. The transfer of information and/or data over a network can be achieved using wired or wireless communications means. A server can facilitate the transfer of data between the network and one or more databases. A server and one or more databases provide an example of an information source.

Thus, the processing computing system environment 100 illustrated in FIG. 1 may operate in a networked environment using logical connections to one or more remote computers. The remote computer may be a personal computer, a server, a router, a network PC, a peer device, or other common network node, and typically includes many or all of the elements described above.

It is to be further appreciated that the logical connections depicted in FIG. 1 include a local area network (“LAN”) and a wide area network (“WAN”), but may also include other networks such as a personal area network (“PAN”). Such networking environments are commonplace in offices, enterprise-wide computer networks, intranets, and the Internet. For instance, when used in a LAN networking environment, the computing system environment 100 is connected to the LAN through a network interface or adapter. When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the computing system environment 100, or portions thereof, may be stored in a remote memory storage device. It is to be appreciated that the illustrated network connections of FIG. 1 are exemplary and other means of establishing a communications link between multiple computers may be used.

FIG. 1 is intended to provide a brief, general description of an illustrative and/or suitable exemplary environment in which embodiments of the below described present invention may be implemented. FIG. 1 is an example of a suitable environment and is not intended to suggest any limitation as to the structure, scope of use, or functionality of an embodiment of the present invention. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

In the description that follows, certain embodiments may be described with reference to acts and symbolic representations of operations that are performed by one or more computing devices, such as the computing system 100 of FIG. 1. As such, it will be understood that such acts and operations, which are at times referred to as being computer-executed, include the manipulation by the processor of the computer of electrical signals representing data in a structured form. This manipulation transforms the data or maintains them at locations in the memory system of the computer, which reconfigures or otherwise alters the operation of the computer in a manner understood by those skilled in the art. The data structures in which data is maintained are physical locations of the memory that have particular properties defined by the format of the data. However, while an embodiment is being described in the foregoing context, it is not meant to be limiting as those of skill in the art will appreciate that the acts and operations described hereinafter may also be implemented in hardware.

Embodiments may be implemented with numerous other general-purpose or special-purpose computing devices and computing system environments or configurations. Examples of well-known computing systems, environments, and configurations that may be suitable for use with an embodiment include, but are not limited to, personal computers, handheld or laptop devices, personal digital assistants, multiprocessor systems, microprocessor-based systems, set top boxes, programmable consumer electronics, network, minicomputers, server computers, game server computers, web server computers, mainframe computers, and distributed computing environments that include any of the above systems or devices.

Embodiments may be described in a general context of computer-executable instructions, such as program modules being executed by a computer. Generally, program modules include routines, programs, objects, components, data structures, etc., that perform particular tasks or implement particular abstract data types. An embodiment may also be practiced in a distributed computing environment where tasks are performed by remote processing devices that are linked through a communications network. In a distributed computing environment, program modules may be located in both local and remote computer storage media including memory storage devices.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

### Software Flow Diagrams

The computer system is programmed to perform the functions illustrated in the software flow charts illustrated in FIGS. 22-28. In one exemplary embodiment of the invention, the computerized system and method may be configured as an exemplary web portal as illustrated in FIG. 21. As will be discussed in more detail below, the web portal may be used to enable customized and standardized structured financial products to be created for investors. In both embodiments, the investment choices are communicated to the general computer system 100. As used herein, investment choices refers to both specific choices by an investor to create a customized structured financial product or choices made to create and/or invest in a standardized structured financial product. The general computer system 100 uses the investment choices to create a customized structured financial product, for example as discussed below and illustrated in FIGS. 2-20 or alternatively a standardized structured financial product to be created and/or listed on an exchange, for example, as illustrated in FIG. 30.

Referring first to FIG. 22, a work flow diagram is illustrated. The work flow diagram illustrates the process of a potential investor creating a customized structured financial product. The workflow for creating, analyzing and investing in a standardized structured financial product would be similar but would not require registration. In this case, after log-in, the investment choices would be input.

With respect to customized products, initially a potential investor 99 logs on to the web portal. Once logged on to the portal, the potential investor 99 is provided access to various offerings, generally identified with the reference numeral 10. These offerings may include information about the web portal host, funds being offered as well as various learning resources. The potential investor 99 can also register with the portal, as indicated by block 12. During registration, the potential investor provides various personal information to create a user profile and user preferences, as generally indicated by the reference numeral 14. The user profile and user preferences are used to generate a user ID that can be used to access a user portfolio 16.

Should the potential investor 99 decide to (i) create a customized structured financial product, (ii) filter on product being offered by the Alliance Program, or (iii) choose from the appropriate listings of standardized products, the potential investor 99 will input one or more user preferences, and various investment choices, for example, as discussed below, which may include the investment strategy, underlying asset, the Fund, protection type, maturity, and price, collectively referred to as “investor choices”, as generally indicated by the box 18. The user preferences and investment choices 18 along with the login authentication data 20, are stored in the database 116 (FIG. 1), as indicated by the box 22 (FIG. 22). The investor choices, generally identified with the reference numeral 18 are also passed to the general computer system 100 (FIG. 1). The investor choices 18 are used to create a custom product under the RFQ Program 26 or allow an investor 99 to choose from the appropriate listings of standardized products under the ETS Program 24 or filter on product being offered under the Alliance Program 28. In the RFQ product 26, the general computer system 100 calculates a price for the ETS Product using the quotes requested from the liquidity providers for the Derivative Component. The liquidity providers use various market data sources 30 and the investor choices 18 to price the Derivative Component. The best quote from the liquidity providers is selected, as indicated by the box 36. The best quote 36 is added to the price for the Fund Component 34 and returned to the investor. Various methodologies are provided below for pricing the Fund Component,

In one embodiment of the invention, as discussed below, bonds purchased from the secondary market are used to create a bond Fund. In that embodiment, the secondary bond market is searched for bonds that meet the criteria defined below, which are suitable to meet the investor's choices. Various brokers may be contacted directly by telephone or through an electronic medium such as a trading platform to obtain price or yield curves for bonds that meet the criteria. As the AUM grow, the computer system 100 can optionally be paired with an Issuance Partner, as indicated by box 93 (FIG. 1). As used herein, an Issuance Partner will encompass various entities such as government agencies, corporations or financial institutions that have agreed to provide a shelf offering up to, for example, $200 million in securities, for example, ranging in maturities over a five year period. In this case, the Issuance Partner automatically provides yield curves to the computer system 100, thus providing direct access to the primary market and a direct relationship with the Funds being issued by the invention. Initially, Funds may be developed by way of the secondary market by pricing bonds directly from brokers and determining a yield based upon the various bonds making up the Fund in order to price the Fund Component. Yields can be determined, for example, by using an averaging process or using various other methods.

In order to price the Derivative Component, the general computer system 100 (FIG. 1) will automatically send out a request to various liquidity providers 97 (FIG. 1) for a quote for the Derivative Component of the ETS Product. The liquidity providers 97 utilize various inputs, for example, a security quote, yield curve, dividend yield and option volatilities, to prepare the quote for the Derivative Component. The quotes from the various liquidity providers for the Derivative Component are returned to the computer system 100 (FIG. 1). Preparation of the quotes for the Derivative Components of the ETS Product by the liquidity provider is outside the scope of this invention. The quotes provided by the liquidity providers can take on several forms, such as (1) dollar price for the derivative component; (2) solving for the upside cap; (3) solving for downside protection; and (4) solving for leverage factor.

The best quote that meets the criteria of the user preferences is selected by the computer system 100 and combined with the price for the Fund Component to generate a total price. If the total price is within the price range included in the user preferences 18, and the investor seeks to execute and make an investment, a security, i.e., structured financial product, is created and stored in the investor's portfolio 16 in the database storage device 116 (FIG. 1). The investor 99 can then check its investment by logging into the system and using its user ID to access the user portfolio 16.

An exemplary web portal for use with the present invention, generally identified with the reference numeral 26, is illustrated in FIG. 21. The web portal 26 enables an investor 99 (FIG. 1) to input user preferences 18 (FIG. 22) to the computer system 100 and determine the available standardized or customized products available from the Alliance Partners, discussed below. Alternatively, a virtually identical web portal may be used by an investor to create a custom structured financial product. In that embodiment, the web portal would not include check boxes to select an Alliance Partner. The exemplary web portal 26 includes a number of check boxes, which allow an investor to select their user preferences 18 (FIG. 22) and transmit their user preferences 18 to the computer system 100 (FIG. 1) to view standardized or customized structured products available by the Alliance Partners that satisfy their preferences, or alternatively to create a custom structured financial product.

Referring to FIG. 21, the investor can select various features of the structured financial product as indicated by the text boxes 37-122. Each of these features is discussed below.

The text boxes 38-41 (FIG. 21) relate to the Alliance Partner Program. Selection of one of the text boxes 38-41 allows an investor to choose and filter customized structured financial products, being issued by an Alliance Partner (i.e., Fidelity ETS). When an investor selects one of the text boxes 38-41, all of the customized structured financial products being offered by the selected Alliance Partner are displayed that meet the criteria the investor selected for filtering purposes.

The system, as designed in the present invention, is flexible and allows an investor to create, filter, analyze and price various customized structured financial products or standardized ETS, as discussed below. Also, the investor can filter and analyze customized financial products issued by several Alliance Partners as illustrated for exemplary purposes: Fidelity Investments 38; Charles Schwab 39 and Wells Fargo 41 (FIG. 21). The ETS customized structured financial products can be branded with various Alliance Partners, such that ETS can analogously be the manufacturer or the “Intel Inside” of the structured product. In this way, the Alliance Partners can market and distribute their own branded ETS (i.e., Fidelity ETS), enabling each Alliance Partner to build equity in their own structured product platform.

The text box 42 (FIG. 21) relates to the investment strategy. The investment strategy 42 can be based on yield 54, optimization 56, leverage 58 or protection 60. There are several options under each investment strategy. Each of these options is known in the investment world. For example, under the yield strategy 54, the following exemplary options are provided:

Reverse Convertible

Digital

Autocallable

Other

Under the optimization strategy 56, the following exemplary options are provided:

Step Up

Digital Step Up

Contingent Step Up

Contingent Digital Step Up

Other

Under the leverage strategy 58, the following exemplary options are provided:

Leveraged 1.5×

Leveraged 2×

Leveraged 2.5×

Leveraged 3×

Other

Under the protection strategy 60, the following exemplary options are provided:

Enhanced Return

Contingent Coupon

Knock out

Range Accrual

Step up

Other

The text box 44 relates to the makeup of the Fund Component, in this case holding a portfolio of fixed income bonds. For example, the Fund Component 44 also provides various exemplary options 62-66. The option 62 relates to corporate bonds from corporations with an “A” credit rating. The option 64 relates to government bonds, such as Treasury notes. Finally, the option 66 relates to bonds issued by financial institutions, such as commercial banks, investments banks, regional banks or broker dealers.

The text box 46 relates to underlying securities or indexes. In accordance with an important aspect of the present invention, the risk associated with an investment in a structured financial product depends, in part, on the gains or losses of an underlying security or index. Several options of an underlying security or index are available, identified with the reference numerals 68-74. Three (3) exemplary types of protection 48 are provided below: continuous barrier 101; barrier at maturity 102; buffer 104; or no protection at all 107. These protections all relate to the downside risk. In particular, if the price of the stock or level of the index, i.e., underlying asset goes up, the investor receives the full amount of the principal at maturity plus the guaranteed yield. However, if the price of the underlying asset goes down, the investor will lose part of the principal as a function of the amount of loss of the underlying asset. For example, if the SPX is down 5% at maturity of the structured financial product and the investor has no protection and has elected the check box 107, the investor would lose 5% of the principal but gain the coupon amount, if applicable.

However, investors can customize their downside risk by selecting a buffer or barrier 104. If a buffer is selected, the investor's principal is protected for a certain amount of loss on the part of the underlying asset. Assuming a 5% buffer, the investor's principal is fully protected up to a loss of 5% of the underlying asset.

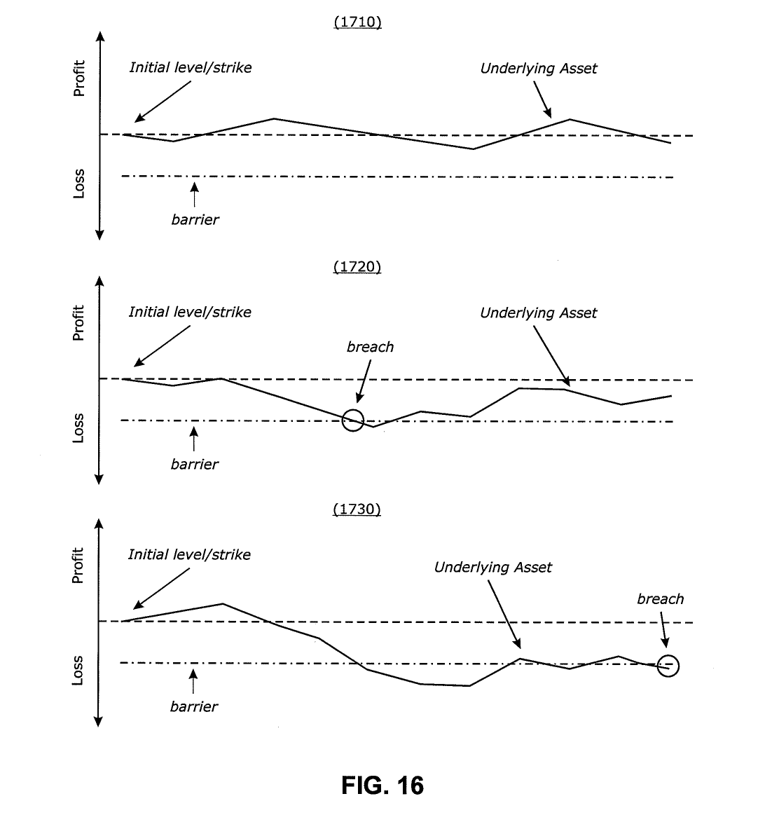

If the buffer 104 is selected, the investor must also select the type of barrier; either a continuous barrier 101 or a barrier at maturity 102. A continuous barrier 100 is defined below in connection with FIG. 16 curve 1720. In this case, anytime the price of the underlying asset falls below the barrier from the time the structured financial product is purchased until its maturity, the protection is considered breached. As can be seen in FIG. 16, even though the level of the underlying asset is above the barrier on the maturity date, since the protection was breached, the investor will lose part of his original principal that is equivalent to the difference in the initial value of the underlying asset and the value on the maturity date. As shown in FIG. 16, the curve 1720 is above the barrier at maturity but below the initial price. The amount of principal the investor will lose is the percentage difference between the level of the underlying asset at maturity and the initial price.

Once the barrier is breached, investors will lose a part of the principal that is below the price or level of the underlying asset relative to the date the structured financial product was purchased. For example, if the level of the underlying asset was 1200 on the date the structured financial product was purchased and on the maturity date the level was 900, the investors would lose 25% of their principal. This amount however, would be offset by the coupon amount of the structured financial product.

The barrier at maturity 102 is similar to the continuous barrier, except the determination of whether protection is breached is only done at the maturity date. The curve 1730 in FIG. 16 illustrates this type of protection. With reference to FIG. 16, it does not matter that the level of the underlying asset went below the barrier before the maturity date. The curve 1730 illustrated in FIG. 16 illustrates a breach on the maturity date. However, if there was not a breach of the protection on the maturity date but instead the level was above the barrier on the maturity date, the investor's principal would be fully protected even though the level of the underlying security dropped below the barrier before maturity.

The investor can also select the protection amount 50. The protection amount relates to the barrier. As discussed above, the barrier is the amount of loss of the underlying asset in which the investor's principal is fully protected. Two (2) exemplary options are provided to describe the filtering process for offerings of customized structured products being offered by Alliance Partners (FIG. 21). The option for filtering the protection amount can range. In this example, the protection ranges from 109 10% to 111 20%.

The investor can also select the maturity 113 of the structured financial product. Exemplary adjustable maturities are illustrated for filtering purposes and/or pricing. The maturity can either be a range for filtering purposes or a fixed maturity for pricing purposes. The maturity range 113 may be adjustable as illustrated between three months 114 and one year 117.

The investor can also filter based on price range for offerings from selected Alliance Partners that match the investor's criteria 52 for the structured financial product. The price range is set using 118 and 120 in FIG. 21 for the nominal unit price of 99.5% and 100%.

The investor is also able to select the minimum potential return 110. An adjustable return 122 may be selected which allows an investor to select a minimum return on the fixed income portion of the structured financial product. An exemplary 12.5% return is illustrated.

A clear button 128 may be provided to enable previous data to be cleared from the web portal. Once all of the selections mentioned above are made by the investor, the investor selects the filter button 124. Once the These options relate to indexes 68; or stocks from various market sectors, such as, the financial sector 70; the technology sector 72; or the energy sector 74.

The option 68 relates to various indexes. As will be discussed in more detail below, although the investors receive their principal back at maturity assuming there are no defaults in the Fund Component, the overall gains or losses are tied to the gains or losses of a linked security or index.

As such, if an investor wishes to link its structured financial product to an index, the investor can check the check box 68 in which case three (3) exemplary choices will be provided: SPX (Standard & Poor Index) 76; QQQ (Nasdaq Exchange Traded Fund) 78; and the RTY (Russell 2000 Index) 80.

Various financial stocks may be offered if the financial check box 70 is selected. Three (3) exemplary stocks are provided for illustration purposes: C (Citigroup) 82; BAC (Bank of America) 84; and GS (Goldman Sachs) 86. The technology stocks 72 may include GOOG (Google) 88; AAPL (Apple) 90; and MSFT (Microsoft) 92. The energy stocks 74 may include: XOM (Exxon Mobil) 96; CVX (Chevron) 97; and BP (British Petroleum) 98.

The various indexes and stocks as well as the market sectors (collectively or individually “asset classes”) are merely exemplary. Other indexes, market sectors and asset classes, such as, but not limited to, equities, foreign exchange, REITs, commodities, and interest rate products are considered to be within the broad scope of the invention.

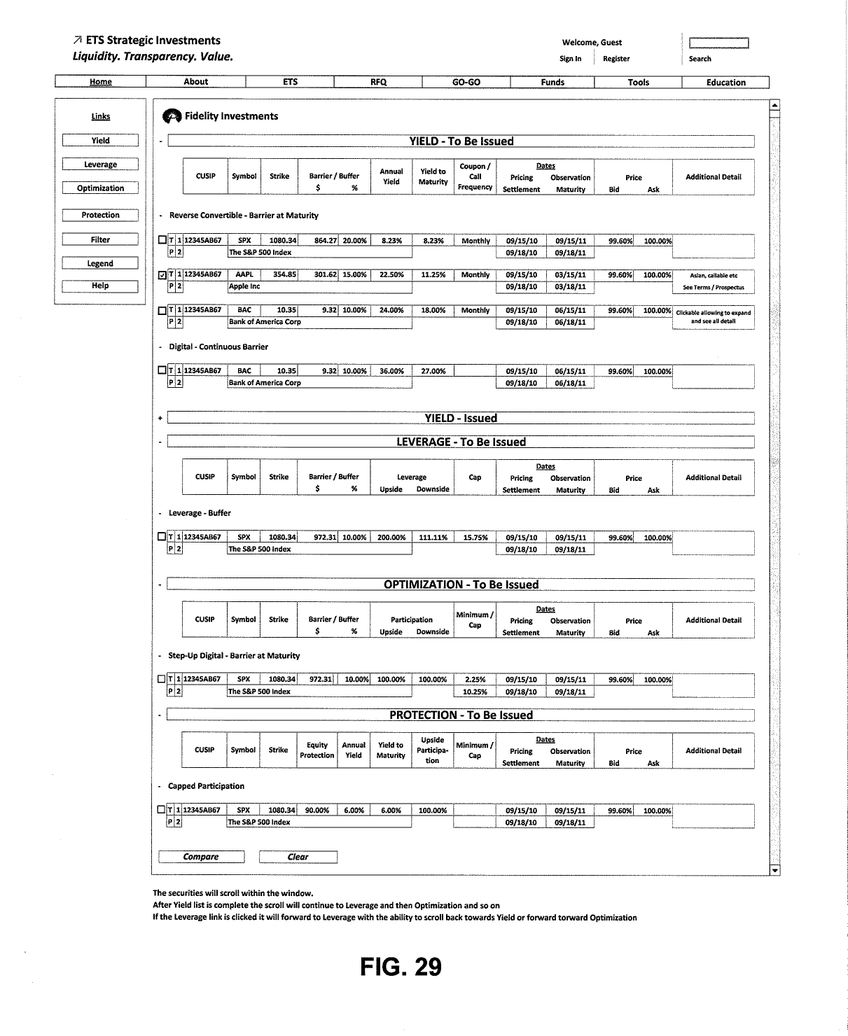

The investor also has the ability to customize the protection type 48. selections are submitted, the selections are stored in the database storage device 116 (FIG. 1) and the structured financial product is filtered in the manner discussed above and below and the standardized products that meet the investor's criteria that are available by the selected Alliance Partner are displayed to the investor, for example, as illustrated in FIG. 29. The investor can then select such structured products for purchase. As shown in FIG. 29, a number of exemplary structured financial products being offered by Fidelity Investments are illustrated.

Alternatively, a web portal, similar to the web portal, illustrated in FIG. 21, can be used in the ETS RFQ program to enable an investor to create a custom structured financial product. In this embodiment, the web portal would not include the Alliance Partner buttons. Also, the Filter button would be a submit button.

The selections depicted in FIG. 21 are merely exemplary. Other custom parameters may be included. In general, the investor choices illustrated in FIG. 21 enable an investor to create or filter a custom risk profile. It is to be understood that the principals of the invention apply to risk profiles that have more or fewer choices for the investor than the examples illustrated. Exemplary software flow charts for the computer system 100 (FIG. 1) are illustrated in FIGS. 23-28. Two scenarios are illustrated. In the first scenario, the system is partnered with an Issuance Partner, as discussed above. In this scenario, the system 100 receives yield data for the selected Fund Component directly from the primary market, i.e., Issuance Partner. The yield data may be used directly by the system 100 to determine the price/yield of the Fund Component of the ETS Product.

In the second scenario, the system 100 obtains price or yield data for portfolio assets of the Fund Component, e.g., bonds from the secondary market, i.e., directly from brokers. These secondary assets are used to create a Fund Component which meets the criteria of the structured financial product, for example, the criteria provided below. The yields and maturity dates for the various assets purchased are then processed by the computer system 100 to provide a Fund Component that meets the choices input by the investor. The bonds purchased in the secondary market will vary in terms of yield and maturity date. For example, for bonds purchased on the secondary market with different maturity dates, the maturity dates are averaged by the computer system 100. For example, a bond with a 1 year maturity date and a bond with a 3 year maturity date may be averaged by a simple average: (1 year)+(2 year)/divided by 2=2 year equivalent maturity date bond. Assuming the yield of the 1 year bond is 8% and the yield of the 3 year bond is 12%, the composite yield may be based upon the weighted averages of the individual yields of the bonds or by using duration based calculations. Other criteria may also be used to determine the composite yield.

### Exemplary Criteria

Selection of the bonds in the primary market or the bonds in the secondary market to create a Fund Component from the secondary market is governed by rules programmed into the computer system 100 (FIG. 1).

Exemplary rules are set forth below:
a. Issuer Specific: A rule may limit the bonds in the fund to issuers with certain characteristic. For example, a United States Government fund may only include bonds that are issued by the United States Government or quasi-United States Government Agencies;
b. Sector Specific: A rule may determine what percentage of a Fund Component comes from certain sectors. For example, a Financial Fund, may have rules governing what percentage of issuers will be Banks/Thrifts, Financial Services Companies and Insurance Companies;
c. Limiting Counterparty Risk: A rule may limit exposure in a Fund Component to any one issuer by providing that principal balance outstanding of bonds from any one issuer shall not be equal to more than 5% of the total principal balance outstanding of the Fund;
d. Limiting Concentration Risk: A rule may limit the exposure in a Fund to any one bond by providing that the principal balance outstanding of all bonds in such Fund Component issued pursuant to any one agreement or supplement or amendment thereof shall not be more than 5% of the total principal balance outstanding of the such Fund Component;
e. Defining Maturity: A rule may provide that all bonds in a Fund Component shall mature no sooner than three years, but no longer than five years, after the creation of the Fund Component;
f. Ratings: A rule may require that the issuer of bonds in a Fund Component must have a credit rating of at least A as established by Moody's and Standard & Poor's;
g. Duration Matching of Assets and Liabilities: A rule may require that there will be no more than a 10% difference in durations when the assets (bond purchases) versus the liabilities (fund component embedded within the sold structured products) are calculated as individual portfolios, i.e., if the liabilities of ETS as defined by the purchases of the structured product has an overall duration of 2 years, the fund must at all times have a matching duration of assets purchased of approximately 1.8 years to 2.2 years, with a target of the assets to be 2 years exactly to offset the liabilities; and
h. Currency: A rule may limit the currency of the bonds in a particular Fund Component. For example, one Fund may require all bonds be payable in United States Dollars, while another Fund may have bonds payable in Euros.

The investor will be able to choose the Fund Component from a list of Funds and see the yield associated with any maturity wanted for the ETS Product. The investor will have the ability to allocate a percentage in numerous Funds, i.e., if the investor wants a blended Fund Component to be 60% Financial Fund and 40% Government Fund, then a blended rate will be constructed and each Fund Component will be allocated a percentage of AUM as defined by the investor at the outset of the purchase of the ETS Product.

Turning to FIGS. 23-28, the system 100 is started in step 130, for example, when an investor logs on to the web portal illustrated in FIG. 21. In steps 132-140, the system 100 receives the investor inputs from the web portal and stores those inputs in the Database Storage Device 116 (FIG. 1), as discussed above.

As mentioned above, there are two different embodiments of the system 100. In one embodiment, the system obtains the required Fund Component from the primary market, i.e., Issuing Partners, with yields that precisely match the investor's choices. In an alternative embodiment, bonds are purchased in the secondary market directly from brokers or electronic trading platforms. In the alternative embodiment, if the system 100 is unable to locate bonds that meet the criteria mentioned above and aggregate a number of bonds that meet the custom choices of the investor, the ETS fund management system (“ETS FMS”), which consists of portfolio managers of the Fund Component working with the computer system 100 (FIG. 1) wherein the portfolio manager will select and purchase bonds in the secondary markets with possibly different maturity dates and yields, and manage the overall portfolio to meet the obligation to maintain a Fund Component with the yield and maturity date selected by the investor.

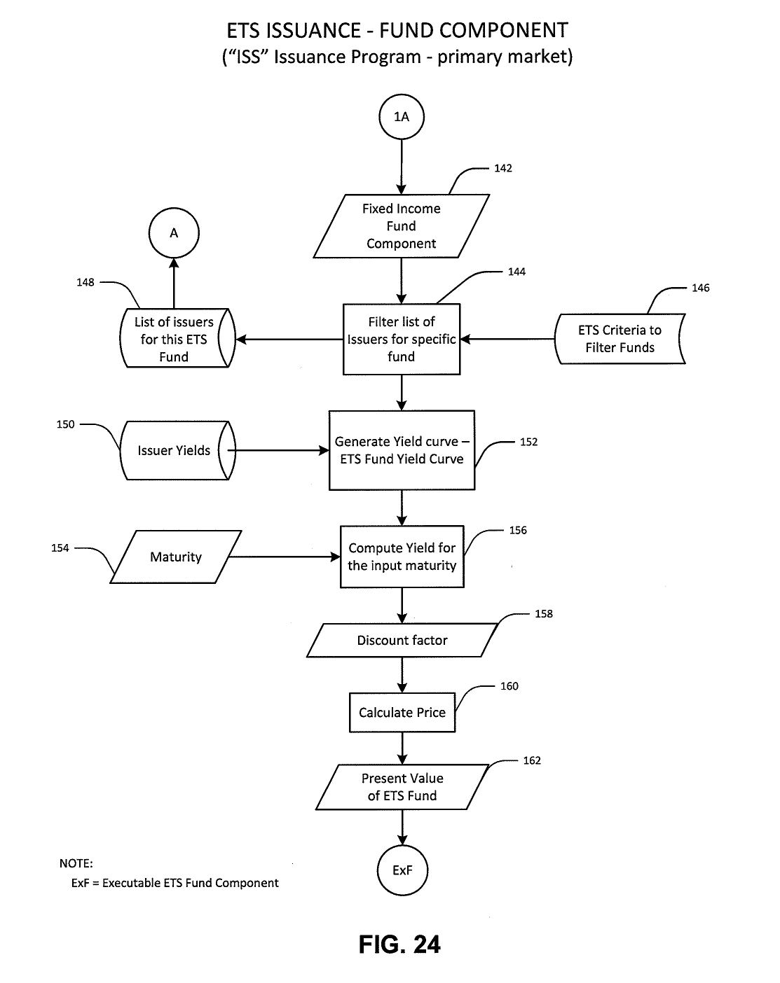

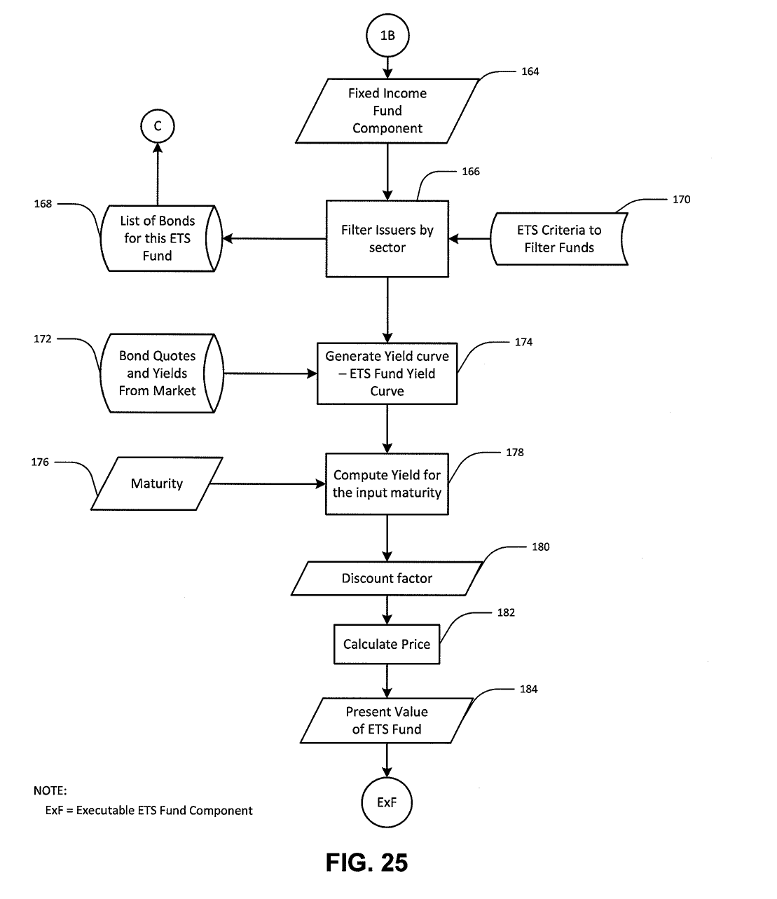

FIG. 24 illustrates an embodiment in which the system has established an Issuance Program comprised of Issuance Partners. FIG. 25 represents an embodiment in which the ETS FMS purchases bonds in the secondary market. In both FIGS. 24 and 25, the ETS FMS determines the price of the Fund Component of the structured financial product in accordance with the present invention based upon information, such as yield, that is fed into the system 100.

Referring first to FIG. 24, the determination of the Fund Component of the structured financial product is represented by the block 142. Initially in step 144, the criteria, as discussed above, is used to select Issuance Partners that meet the criteria in steps 146 and 148. In step 152, the system grabs the yield data 150 from the Issuance Partner and uses it in calculating the yield for the fixed income fund. In step 156, the system 100 computes the yield based upon the maturity 154 selected by the investor. Next, in step 158, the system computes the discount factor.

Various formulas can be used for the discount factor. One such formula is 1/(1+r)^{T}, where r=the interest rate and T equal the number of periods of time in years. Thus, for a Fund Component with yield of 5% and a maturity of 1 year, the discount factor would be 1/(1+0.05)¹ or 1/1.05 or 0.952. If the Fund Component of the structured financial product is sold in increments of $100 USD, the price of the Fund Component is calculated in step 160 by multiplying the discount factor by $100 to get the per unit price. Using the example above, the per unit price would be 0.952×$100 or $95.20. In step 162, the present value of the Fund Component is calculated by multiplying the number of shares by the per unit price.

FIG. 25 is similar to FIG. 24 except in this embodiment, bonds are purchased in the secondary market by the ETS FMS, as discussed above. In this embodiment, the system 100 calculates the yield in the manner discussed above. Box 164 represents the initiation of the process of obtaining bonds in the secondary market and computing the Fund Component of the structured financial product. Based upon the available choices for the fund 168 and the criteria 170 for the Funds, as discussed above, the ETS FMS obtains quotes directly from brokers in the secondary market in step 172. The bid and offer market data is used by the system 100 to calculate a yield in step 174. In step 178, the yield is determined based upon the investor's selected maturity 176. Then the ETS FMS buys the bonds and may transact with the Issuing Partners to offset the Fund Component liabilities. Steps 180, 182 and 184 are virtually the same as steps 158, 160 and 162, described above in connection with FIG. 24.

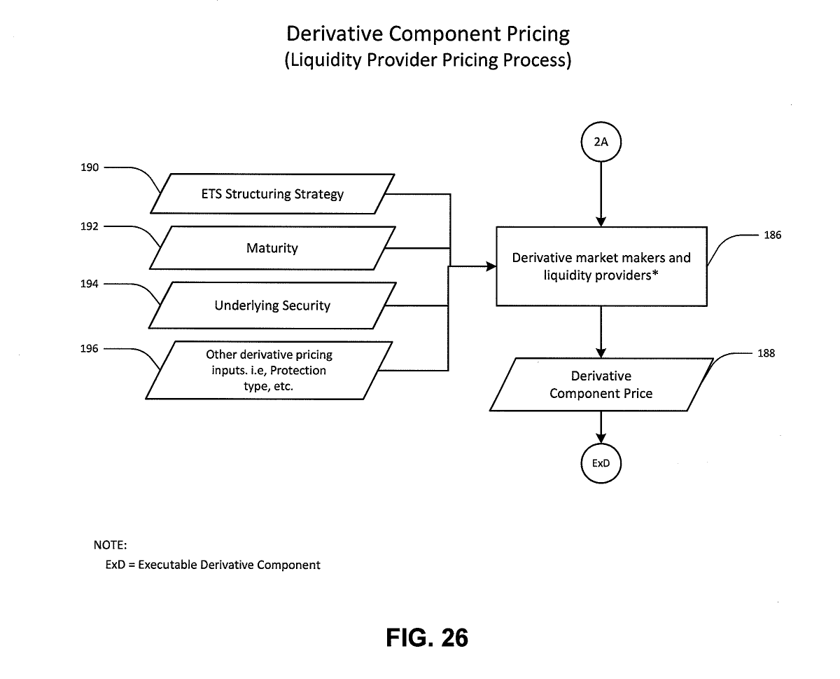

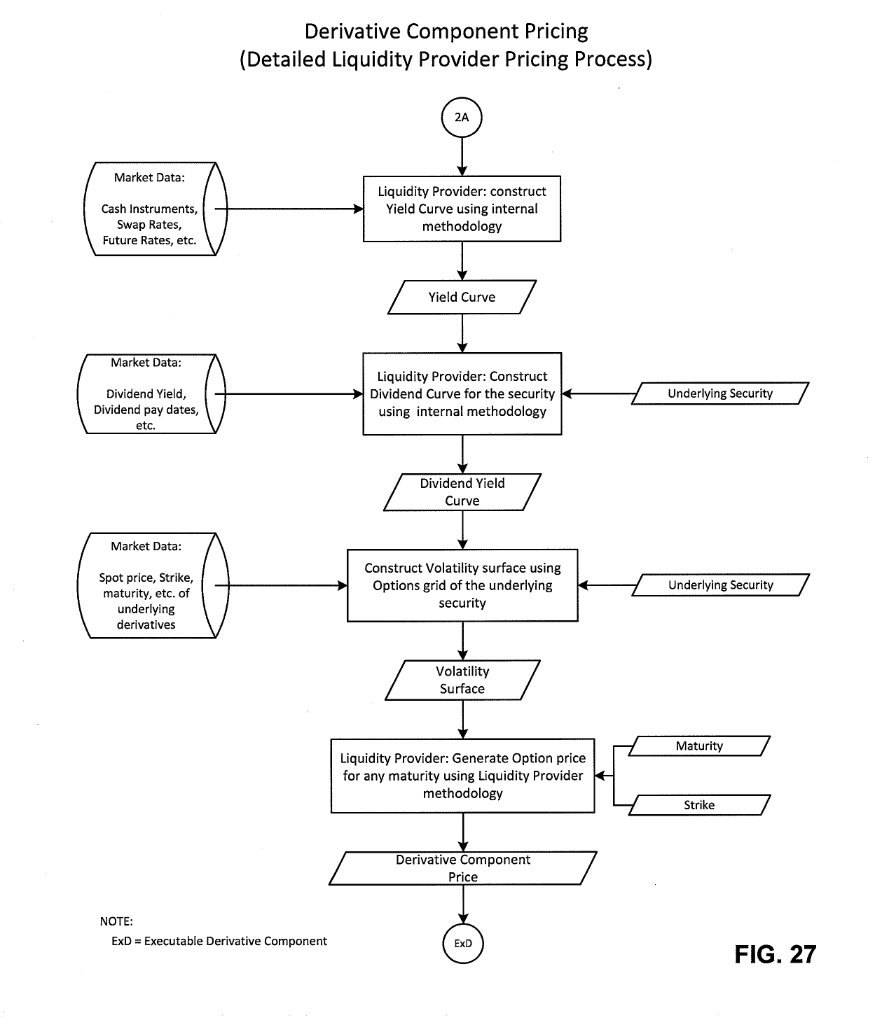

Simultaneously when the Fund Component of the structured financial product is computed, the system 100 sends a request for quotation out to liquidity providers to provide a quote for a Derivative Component that meets the risk profile that the investor input onto the web portal. As indicated in FIG. 26, the liquidity providers provide a quote for the Derivative Component to the system in steps 186 and 188. The liquidity providers consider various criteria in preparing the quote for the Derivative Component. These criteria include: structuring strategy 190; maturity 192; underlying security 194 and other derivative pricing inputs 196, such as protection type. A more detailed flow chart for the derivative pricing is provided in FIG. 27. However, the pricing strategy for the Derivative Component is not part of the present invention.

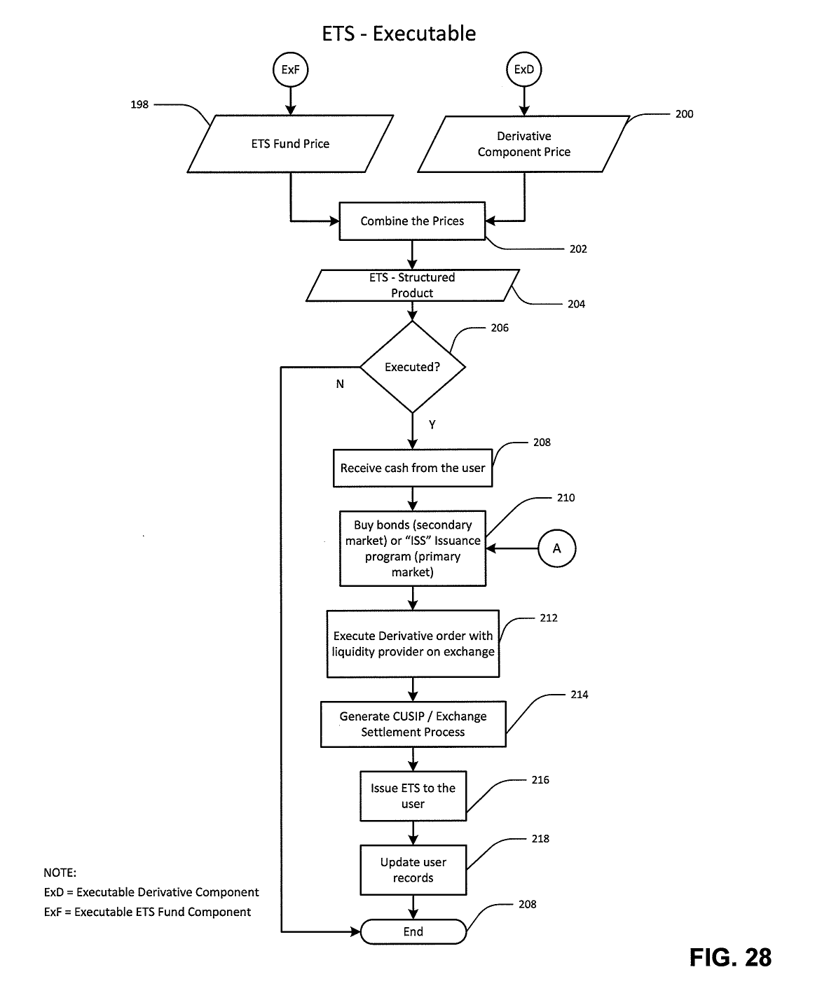

Referring to FIG. 28, the prices for the Fund Component 198 and the Derivative Component 200 are combined by the system 100 in step 202. This price is inserted into the financial instrument for the structured financial product in step 204. In step 206, a determination is made whether a contract for the structured financial product was executed by the investor. If not, the process of issuing a customized structured financial product is terminated in step 208. If the contract was executed, the investor makes payment or gives permission to debit its investment account in step 208. The cash is used in step 210 to buy assets or bonds in the primary market “ISS” or in the secondary markets. In step 212, the derivative order is executed with the liquidity provider. In steps 214 and 216, the financial instrument for the security is generated and issued to the investor. In step 218, the records of the investor are updated, for example, as illustrated in FIG. 29.

FIG. 30 illustrates an exemplary web page of standard ETS Product, as discussed below, with different risk profiles that can be cleared and settled on an exchange, and new ETS Product listed on a periodic basis, for example, every third Friday of the month. As shown, various structured products are illustrated. Each product is represented by a box. The boxes are arranged in rows and columns. The rows represent specific fixed income funds and risk profiles. For example, in the exemplary illustration shown, the rows are identified with the reference numerals 222, 224, 226, 228 and 230. The columns are represented by the reference numerals 232, 234, 236 and 238. Each row represents a particular Fund Component and risk profile. For example, the rows 222, 228 and 230 represent Corporate “A”, Government and High Yield fixed income funds, respectively. For example, the rows 222, 224 and 226 represent that the underlying asset is the S&P Index structured as a reverse convertible with a 10% continuous barrier. The dates at the top of each column, for example Nov. 8, 2012, represent maturity dates for the structured financial product. The number of days above each column, for example 91 days, represents the days from the current date, for example, Aug. 9, 2012, to the maturity date.

As mentioned above, each box represents a different structured product which was created by the system 100 based upon certain investment choices, for example to create standardized ETS structured financial products that are periodically available on an exchange.

The data in each of the boxes is explained with respect to the box 240. With reference to the box 240, the number 4.72% represents an upside cap. In other words the investor will not benefit from increases in the Fund Component greater than 4.72%. The number 99.6 represents the bid price while the number 100 represents the ask price. The number 2000 represents the size of the bid and the number 5000 represents the size of the offer.

The standard ETS Product may be created by the system 100 with choices predetermined and traded on an exchange. In accordance with another aspect of the invention, the system 100 is able to create the ETS Product, discussed above, on a rolling basis and create an ETS ETF based on the value of the ETS on the maturity date using the initial choices or new investment choices. In other words, the ETS ETF does not expire but simply rolls over to a new maturity date. The ETS FMS will develop ETFs on the most popular ETS Products. The ETS ETF will allow an investor to enter a preferred strategy with no explicit expiration date. Essentially, it is a mechanism to automatically roll the strategy forward in perpetuity and have no final maturity, just like common equity. On a rolling basis, the system will automatically roll forward a portion of the investment in the ETS ETF, maintaining the initial criteria of the structured product in order to maintain the exposure in the underlying strategy. In other words, the ETS ETF does not mature but simply rolls over to a new maturity date.

### Illustrative Embodiments of Potential Structured Financial Products that can be Produced by the General Computer System

With reference now to FIGS. 2-4, illustrated are diagrams in accordance with illustrated embodiments of the present invention. It is to be understood and appreciated the present invention system 100 preferably utilizes a Fund Component in place of the issued note. The utilization of a Fund Component results in lower levels of credit risk as compared to current practice, mitigated counterparty risk, and, at the same time, dramatically increasing investor flexibility and customization. Funds 110 are incorporated either by the direction of the fund sponsor into the present invention system 120 (FIG. 2), or Funds 210 are incorporated by an investor 220 (FIG. 3) into the present invention system 230. Alternatively, and with reference to FIG. 4, Funds 310 are incorporated by a third party (320) into the present invention 330.

It is to be appreciated and understood, the process of incorporating a Fund is not limited to the three processes illustrated in FIGS. 2-4. Preferably, the process will primarily be done via computer system 100 but is not to be understood to be limited thereto as any appropriate means may be utilized as by any other source of electronic communication (i.e., telephone).

With regards to FIG. 2, the present invention system 120 preferably combines the relevant strategy in the Derivative Component 130 to the Fund Component 140 in order to create a Structured Product 150. In the process, the present invention system 120 chooses which Fund(s) 110 to include as the Fund Component 140. The process can, and may be iterative, whereby the fund sponsor 120 may choose to create multiple Structured Product 150 based on the same strategy within the Derivative Component 130 but with differing Funds 110. Thus, providing investor flexibility to choose the preferred Fund Component in matching their risk/reward profiles.

Regarding the illustrated embodiment of FIG. 3, the investor 220 communicates to the present invention system 230 the fund(s) 210 of its choice in creating the Fund Component 250 to combine with the Derivative Component 240 in creating a structured product 260. The investor has the ability to choose one or more Funds 210 in the construction of its structured product 260. It is to be understood and appreciated this process introduces an additional level of flexibility and customization allowing the investor the ability to choose a Derivative Component and the Fund Component in creating a structured product 260.

With regards to the illustrated embodiment of FIG. 4, a third party 320 communicates to the present invention system 330 the Fund(s) of its choice 310 in creating the Fund Component 350 to combine with the Derivative Component 340 in creating a structured product 360. It is to be understood and appreciated the third party will have the ability to choose more than one fund 310 in the construction of their respective structured product 360. It is to be acknowledged and appreciated that an advantage of this process is that it will open the industry to wealth managers and the like to introduce strategies that they believe are beneficial to the investor.

It is to be appreciated and understood the Fund Component itself will be managed like a traditional fund with the major differentiator being that the Fund Component will need to manage investments to known terms based on investor interest.

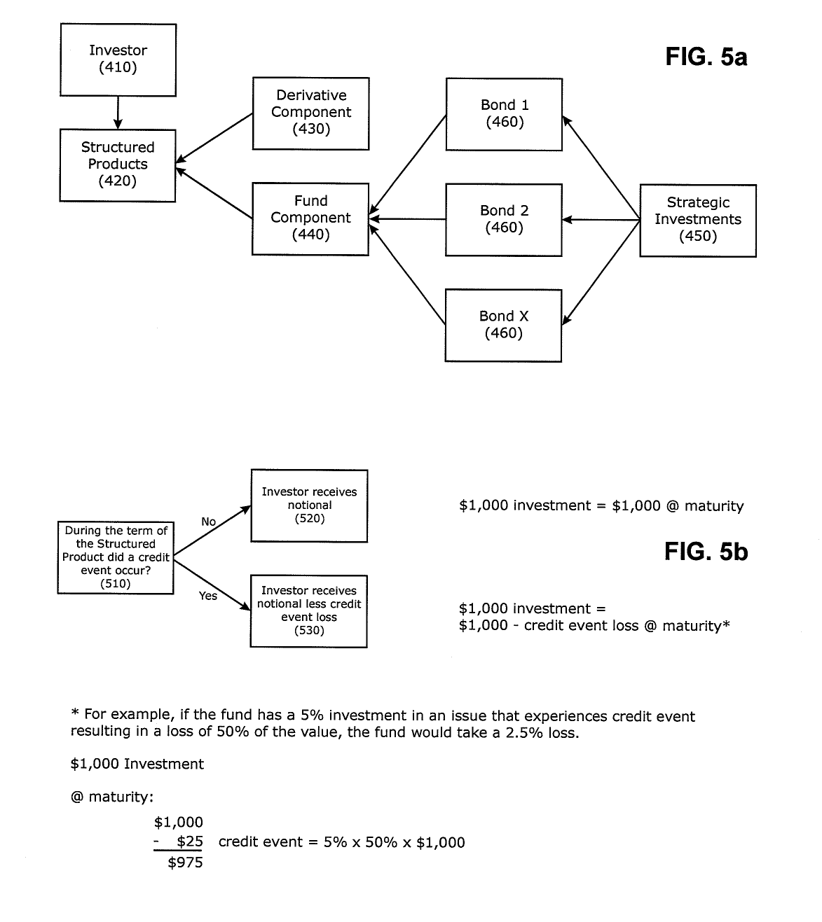

Turning now to the illustrated embodiment of FIGS. 5a and 5b, the investor 410 makes a notional investment, for example $1,000 into a structured product 420 with a pre-defined maturity. At maturity, barring a credit event, the Fund Component 440 will payout the notional amount, in this example $1,000. It is the present invention system 450 responsibility to manage towards the expected payout based on no credit events. (It is to be understood and appreciated that there is a Derivative Component of a structured product which is typically the conduit that enables investors to generate returns above the initial investment).

With reference to FIG. 5b, the diagram exhibits the payout at maturity for the Fund Component based on whether a credit event occurs 530 or does not occur 520. As can be seen, in the event there is no credit event 520, the investor receives the return of their investment. It is to be appreciated this illustration ignores the outcome of the Derivative Component. For example, a $1,000 investment would result in the return of $1,000 at maturity. However, a credit event affecting a 5% Fund Component position in which the expected loss is 50% would result in a $25 loss on a $1,000 investment. The investor would receive $975 at maturity from the Fund Component.

Discussion will now turn to a method of accessing an issuance program created for the Fund Component of a structured product. It is to be understood that currently the issuing banks raise a material amount of their funding needs through structured products. For instance, in 2010, Barclays raised roughly 60% ($34 billion) of total funding needs of $57 billion from structured product issuance, primarily in the United States market. It is noted this is a very beneficial source of funding for the small group of issuing entities in the United States. In accordance with an illustrated embodiment, the present invention provides an innovative issuance program whereby, utilizing a computer system, qualified corporations will be able to directly access this unique source of funding by partnering with the present invention system 100 and populating the funds.

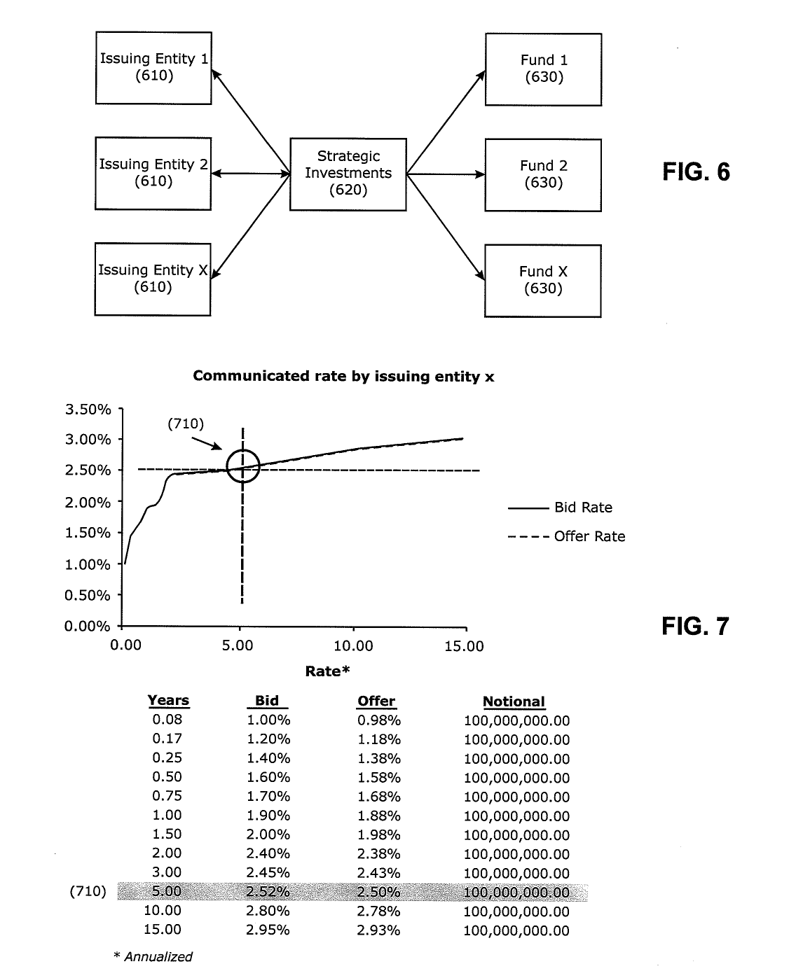

With reference to FIG. 6, the issuing entities 610 will continuously send rate data by maturity in addition to size of funding notional to the fund sponsor 620. The fund sponsor 620 will allocate potential purchases of the issuing entities paper to respective Fund 630 based on both the rules of the underlying Fund 630 and the established rate. In this process, the fund sponsor preferably creates a forward rate for the respective Fund. As purchases of the relevant products by the investors take place, the fund sponsor 620 preferably communicates back, via computer system 100, to the issuing entities 610 the relevant maturity and notional amount.

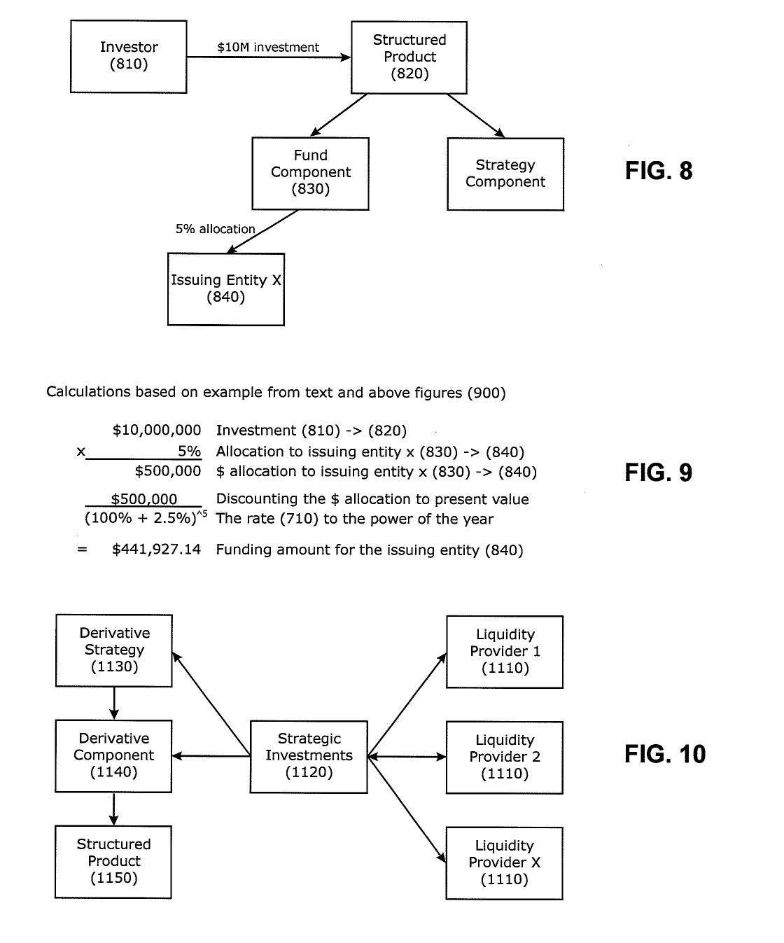

With reference now to FIGS. 7 and 8, and as an example, an investor 810 purchases $10 Million of a structured product 820 with a 5 year maturity. The Fund Component 830 chosen by the investor holds a 5% position in issuing entity x (840) paper. Based on illustration depicted in FIG. 7, the annualized rate for issuing entity x (710) is 2.5%. In practice, continuous compounding would most likely be used, however, in order to simplify the example, annualized compounding is used. Thus, the fund sponsor, via preferably the Fund Component 830 would fund the issuing entity 840 $441,927.14 in return for $500,000 in 5 years. It is noted, all calculations are detailed in FIG. 9. At this point, the funding entity notional will automatically reduce by the amount of funding.

Discussion now turns to a method for embedding competitive process in the Derivative Component of a structured product. It is to be understood a second component is the Derivative Component of a structured product. It is also to be understood, industry practice is to have the internal trading desk price this Derivative Component and embed it to the issued note thus creating a structured product. Additionally it is to be understood and appreciated the present invention utilizes a dynamic, competitive process involving multiple liquidity providers in place of a single trading desk pricing process. It is noted the utilization of a competitive process increases price competition, liquidity, and transparency, materially reducing the cost to the investor.

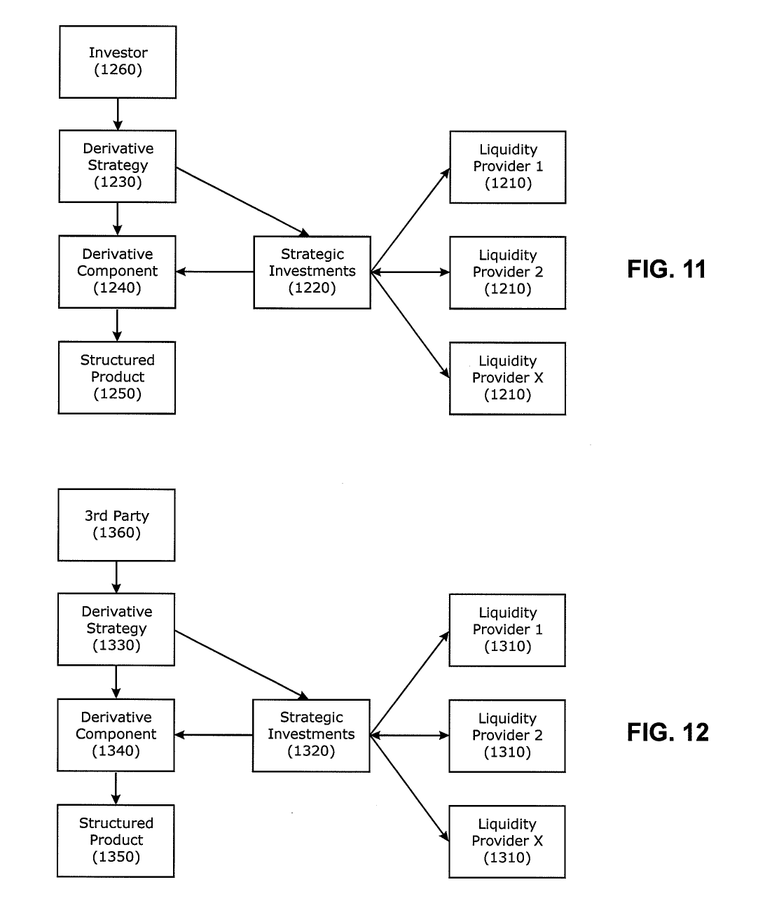

With reference now to FIGS. 10-12, the Derivative Component is initiated either by the direction of the present invention (FIG. 10) into what is termed the structured product or by the investor (FIG. 11) into what is termed the RFQ or by a third party FIG. 12 into what is termed the Alliance Partner. Preferably, the process will primarily be done via computer system 100, but is not to be limited thereto as it will have the ability to be done by any other source of electronic communication (i.e., telephone).

With reference to FIG. 10, the present invention system 1120 preferably creates the relevant Derivative Strategy 1130. The terms of this Derivative Strategy are communicated (via a computer system 100) via the present invention system 1120 to the Liquidity Providers 1110 who then preferably communicate back to the present invention system 1120 with a two sided market and notional size. The present invention system 1120 compiles the bids and offers in making a composite market that feeds into the Derivative Component 1140. The Derivative Component then preferably feeds into the structured product 1150.

With regards to FIG. 11, the investor 1260 creates the Derivative Strategy 1230 utilizing various tools available via the present invention system 100. The terms of the Derivative Strategy 1230 are preferably automatically communicated to the present invention Strategic Investments 1220 (the issuing entity of the ETS Products) that then follows the same procedure as explained with reference to FIG. 10. That is, the terms of the strategy are communicated, via the present invention computer system 1220 to the Liquidity Providers 1210 who then communicate back to the present invention Strategic Investments with a two sided market and notional size. The present invention Strategic Investments 1220 compiles the bids and offers in making a composite market that feeds into the Derivative Component 1240. The derivative component then feeds into the Structured Product 1250.

With reference now to FIG. 12, this illustrated embodiment is substantially the same as that of FIG. 11 except for the fact that a third party 1360 creates the relevant strategy 1330 utilizing various tools available via the present invention system 100. The terms of the Relevant Strategy 1330 are preferably automatically communicated to the present invention Strategic Investments 1320. The terms of the strategy are communicated (preferably via computer system 100) via the present invention Strategic Investments 1320 to the liquidity providers 1310 who then communicate back to the present invention Strategic Investments 1320 with a two sided market and notional size. The present invention Strategic Investments 1320 preferably compiles the bids and offers in making a composite market that feeds into the Derivative Component 1340. The Derivative Component then preferably feeds into the Structured Product 1350.

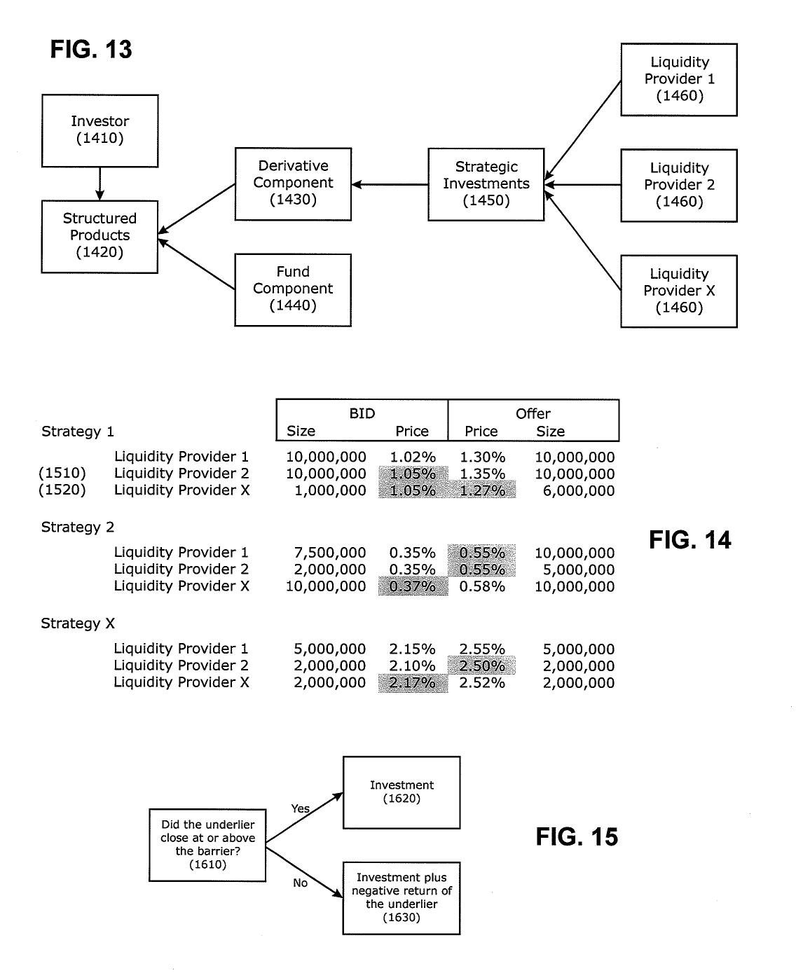

It is to be appreciated that for all aforesaid present invention products (e.g., structured product, RFQ, etc.) Issuance Partners either send continuous, automated quotes or quotes at specified intervals and on demand to the present invention system 100. As will be explained further below, this creates liquid, secondary markets. With reference now to FIGS. 13 and 14, illustrated is the process of valuing the bid and offer side of the Derivative Component in constructing the present invention products. It is to be understood all liquidity providers 1460 communicate via computer system a two sided market and notional size FIG. 14 to the present invention system 1450. The present invention system 1450 and/or a licensed representative then preferably compiles the best bid and offer side in communicating (via computer system) a single bid/offer spread and notional size for the derivative component 1430 which then is combined with the Fund Component 1440 to create the Structured Product 1420. The investor 1410 will have access, depending on the specified product, through an exchange, brokerage, website and/or alternative methods to the structured product 1420.

FIG. 14 illustrates through the shading of the pricing, a composite market. For instance, in strategy 1, the best bid of 1.05% is shared by liquidity provider 2 1510 and Liquidity Provider X 1520. The present invention system 100 preferably sums the notional size resulting in a composite bid of 1.05% for $11,000,000 notional. On the offer side, liquidity provider X 1520 is offering $6,000,000 notional at 1.27%. Since this is the best offer, the composite offer remains the same, $6,000,000 notional at 1.27%. Therefore, the derivative component 1430 market would be 1.05%-1.27%, with notional size of $11,000,000-$6,000,000.

It is to be understood and appreciated one of the beneficial characteristics of a structured product is its flexibility and customization which allows investors to mold a product to their own specified risk/reward profile. For instance, FIG. 15 illustrates an example of a specific, popular strategy within the structured products industry. The reverse convertible strategy with a barrier at maturity is one where the investor collects a coupon, traditionally monthly, which is guaranteed. In return for this coupon, if at maturity the level of the underlying asset is below the specified level (Barrier), the investor will take a loss on the initial principal investment.

It is noted there are only two outcomes for a reverse convertible with a barrier at maturity when isolating the Derivative Component. Thus the pertinent query is did the underlying asset close at or above the barrier at maturity (1610): if the answer is yes then investor receives the return of their initial investment (1620). If the answer is no, then investors receive the return of the investment less the absolute value of the decline in the underlying asset (1630). Preferably, in both scenarios, the investor receives monthly payments.

For instance, FIG. 16 illustrates a few scenarios. All the charts have a line labeled barrier—if the underlying asset is below the barrier at maturity (the right end of chart) (1730), then the barrier is considered breached and the investors would lose a portion, and possibly all of their initial investment (1630). If the underlying asset never breaches the barrier (1710) or even if it breaches the barrier during the term of the structured product but closes on maturity above the barrier (1720), the investors receive the return of their full principal. As stated above, the investor preferably receives coupon payments regardless of the outcome of the underlying asset.

It is to be appreciated and understood this strategy is advantageous in that it provides an investor an enhanced yield relative to a fixed income bond. The yield will primarily be based on the volatility, which is a measurement of the movement of the underlying asset, the level of the barrier and the time to maturity.

Discussion will now turn to a method of utilizing a fixed income fund as the Fund Component of a structured product. It is noted, industry practice is to utilize an issued note which results in concentrated counterparty and credit risk and low levels of flexibility and customization of the Fund Component. It is to be understood and appreciated that utilizing a creation and redemption process is significant to creating an efficient market by allowing the ability to increase or reduce the size of a strategy and fund and in providing a lower cost structure and more liquid process to the liquidity provider allowing for the reduction of costs to flow to the investor.

In accordance with the illustrated embodiments of the present invention, the process created is unique in the transfer, in that a cleared derivative contract is sent in addition to the created structured product. As discussed further below, in addition to the many other advantages of utilizing a creation/redemption process, the addition of a cleared derivative contract allows for lower hedging costs for the liquidity providers.

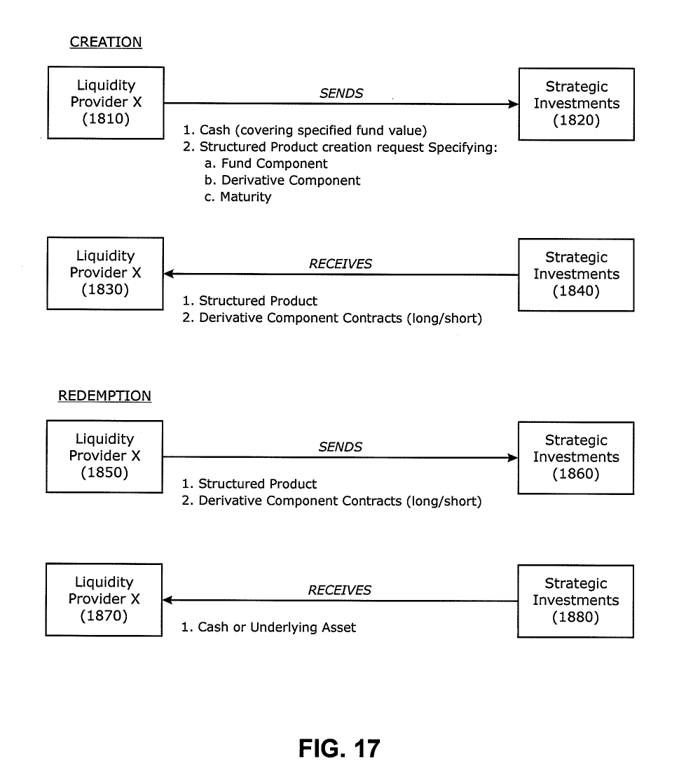

FIG. 17 depicts the process of creating and redeeming a structured product wherein liquidity providers take the opposite side of investor positions. Once a liquidity provider has a position in the structured product, an effective method of hedging the position is by creating or redeeming the respective structured product. When an investor purchases a structured product in accordance with the present invention, the liquidity provider becomes short the structured product. In order to create the structured product, the liquidity provider (1810) would send (1) cash and (2) instructions specifying the correct structured product by identifying the (a) Fund Component, (b) Derivative Component and (c) the maturity of the structured product to the present invention (1820). In return, the liquidity provider (1830) would receive the (1) structured product securities and (2) Derivative Component from the present invention (1840). Preferably, the end result is that the investor would be long the structured product securities, the liquidity provider would be long and/or short cleared Derivative Component based on the strategy, and the present invention system 100 would receive an increase in AUM in the specified Fund for the specified notional and offsetting positions in the Derivative Component, one embedded within the created structured product and one exchanged within the creation process with the Liquidity Provider. As can be seen, the residual position for the present invention is simply long a Fund position.

Conversely, when an investor sells a structured product, the liquidity provider becomes long the structured product securities. In order to redeem the structured product, the liquidity provider (1850) would send (1) structured product securities and (2) the Derivative Component to the present invention system (1860). In return, the liquidity provider (1870) would receive (1) cash or the equivalent value of the underlying asset from the present invention system (1880). Preferably, the end result is that the investor would either be short Fund Components (in which case a borrow must be located) or closed out of a long position, the liquidity provider would have either a flat position (due to close out) or a position in Derivative Components (through selling a short position), and the present invention system 100 would pay out cash or an equivalent value of the underlying asset resulting in a decrease in Assets Under Management (AUM) in the specified Fund for the specified notional and offsetting Derivative Components in similar fashion to the Creation process. As can be seen, the residual position for the present invention would be a reduction of Fund assets.

Discussion will now turn to creating a complete structured fund process. It is to be appreciated and understood that while each of the above described methods, on their own, solve a number of the issues currently plaguing the structured product industry, when combined, most major issues are solved resulting in an efficient, low cost market providing a unique product to the investment community.

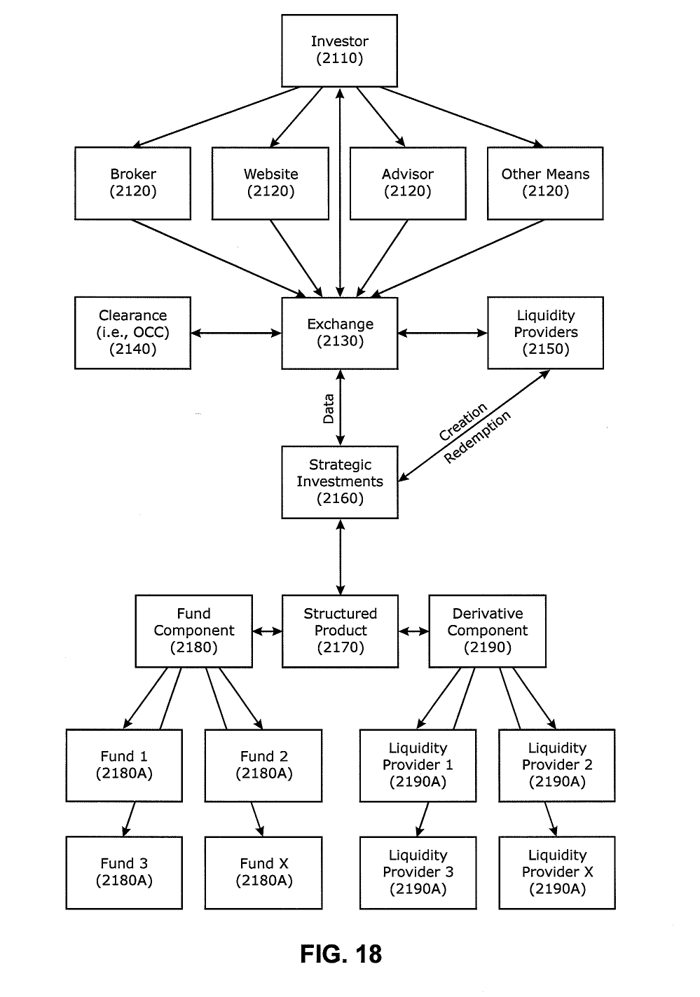

With reference now to FIG. 18, this flow diagram combines the unique methods described above as applied to an exchange listed structured fund. Thus, an investor (2110) would access the Exchange (2130) in a multitude of processes (2120) including but not limited to Brokers, Websites, and Advisors. All products are preferably cleared (2140) and competitively priced by liquidity providers (2150). The Liquidity Providers (2150) preferably base bid and offer spread on data provided from the present invention system (2160) to the Exchange (2130), in addition to additional variables that affects trading on exchanges such as supply and demand and hedging costs. The present invention system (2160) will continuously disseminate data to relevant third parties potentially including but not limited to Exchanges, liquidity providers and investors based on the compiled bid-offer of the Fund Component (2170). In turn, the Fund (2170) will continuously update based on the Fund Component (2180) and its sources (2180A) (as depicted and explained above) and the Derivative Component (2190) and its sources (2190A) (as was also discussed in the above discussed illustrated embodiments).

Once the Investor (2110) purchases (or sells) a structured product (2170), the liquidity provider (2150) who transacts with the investor (2110) will have the ability to create (or redeem) the structured product (2170) through the present invention system (2160). Investors will receive their structured funds securities purchased (or cash if sold) from the exchange (2130) through their original access points (2120).

It is to be appreciated and understood an RFQ is more bespoke than a structured product. As opposed to the investor simply purchasing a pre-packaged structured product on the securities exchange, RFQ allows the investor to create a tailored investment. This allows extreme customization by allowing the investor to choose the appropriate Fund (or Fund Components) and Derivative Component in creating a structured product. Given the level of customization, it is not necessarily viable to have every bespoke RFQ listed on an exchange and at times will not be viable to have continuous markets provided. Thus, the RFQ enjoys the additional benefit of extreme flexibility and customization in return for a lesser degree of liquidity while still taking advantage of the many unique features developed by the present invention system 100.

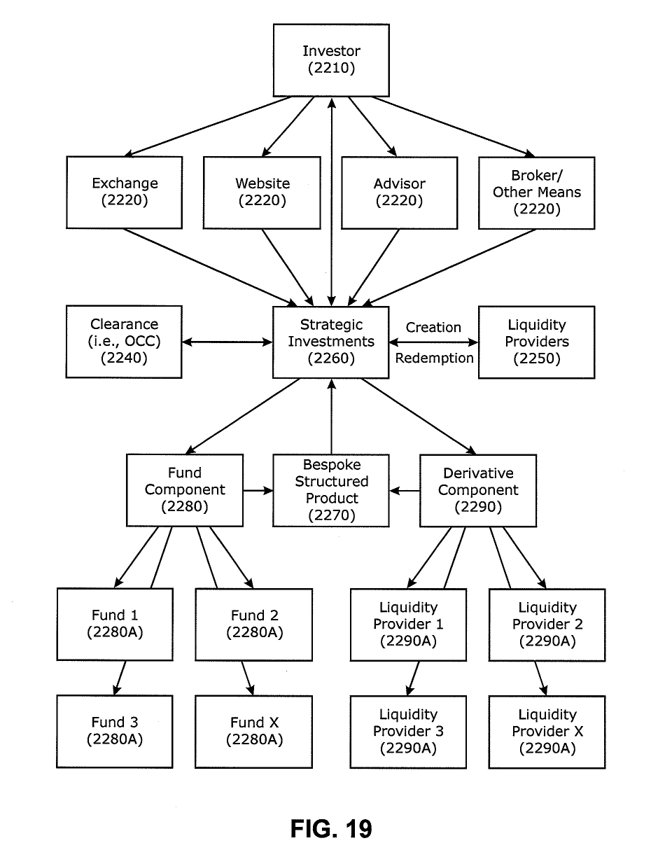

With reference now to FIG. 19, this flow diagram illustrates the unique methods described above as applies to a RFQ. Accordingly, an Investor (2210) would access the present invention system (2260) portal in a multitude of processes (2220) including but not limited to exchanges, brokers, websites, and advisors. Note that investor (2210) access is through the present invention system (2260) as opposed to the exchange as explained above with reference to FIG. 18. Through the present invention system (2260) portal, the investor (2210) will customize the Fund Component (2280) by choosing the requisite Fund (2280A) and the Derivative Component (2290) in which the liquidity providers (2290A) will provide competitive markets. Once the investor (2210) is satisfied with the product, an RFQ (2270) will be created. As in the structured product (2100) (FIG. 18), the RFQ product is preferably cleared (2240) and competitively quoted by liquidity providers (2250).

Once the investor (2210) purchases (or sells) a RFQ (2270), the liquidity provider (2250) who transacts with the investor (2210) will have the ability to create (or redeem) the RFQ (2270) through the present invention system (2260). Investors preferably receive their RFQ (2270) shares purchased (or cash if sold) from the present invention (2260) through their original access points (2220). Depending on the specific variables of the investment, secondary markets will range from on-demand to continuous.

It is noted that an Alliance Partnership Product is a present invention product created in an association between the present invention system and a third party. For example, a wealth management company that believes a certain strategy utilizing the present invention product would allow investors to achieve strong returns relative to the market. Thus, the Alliance Partnership Product is a mechanism allowing third parties to utilize the present invention advantage for the benefit of its client base. Depending on a number of metrics, such as notional size and number of investors, the Alliance Partnership Product may either be listed on an exchange or accessed through the present invention system. As in the RFQ, secondary markets will vary from on demand to continuous.

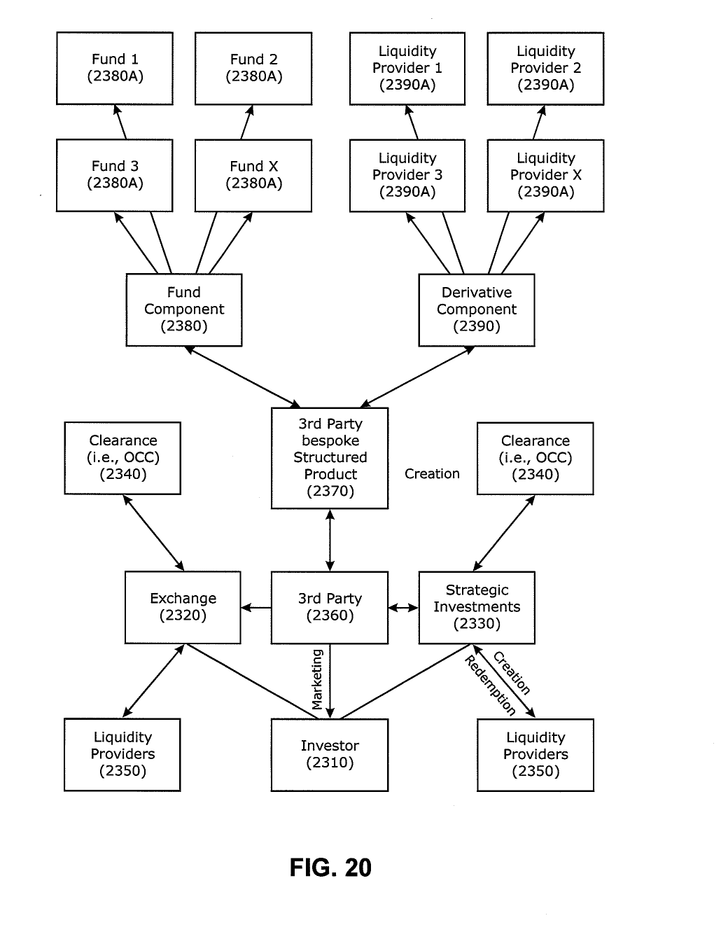

With reference now to FIG. 20, this flow diagram illustrates the unique methods described above as applied to a Alliance Partnership Product wherein a third party (2360), with the assistance of the present invention system (2330) would create a Alliance Partnership Product (2370) by choosing a fund(s) (2380A) for the Fund Component (2380) and by developing a strategy utilizing the present invention system (2330) tools in creating a Derivative Component (2390). The derivative component (2390) preferably goes through the competitive bidding process (2390A). Once the Alliance Partnership Product (2370) is created, the third party (2360) is preferably responsible for marketing to its investors (2310). It is noted that the Alliance Partnership Product would also be available and marketed via the present invention system (2330) website and, based on certain metrics, alternatively an exchange (2320). The Alliance Partnership Product is also preferably cleared (2340) and will enjoy the benefits of a competitive pricing process through liquidity providers (2350). Once the investor (2310) purchases (or sells) a Alliance Partnership Product (2370) via access of an exchange (2320), the third party (2360), the present invention system (2330), or another means, the liquidity provider (2350) who transacts with the investor (2310) will have the ability to create (or redeem) the Alliance Partnership Product (2370) through the present invention system (2330). The investor preferably receives their Alliance Partnership Product (2370) securities purchased (or cash if sold) from the present invention system (2360) through either the third party (2360), an exchange (2320) or directly from the present invention system (2330). Depending on the specific variables of the investment, secondary markets will range from on-demand to continuous.

A further description of the present invention can be found in Exhibit A.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

The above presents a description of a one mode contemplated for carrying out the present invention, and of the manner and process of making and using them, in such full, clear, concise, and exact terms as to enable any person skilled in the art to which it pertains to make and use these devices and methods. The present invention is, however, susceptible to modifications and alternative method steps from those discussed above that are fully equivalent. Consequently, the present invention is not limited to the particular embodiments disclosed. On the contrary, the present invention encompasses all modifications and alternative constructions and methods coming within the spirit and scope of the present invention.

The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention.

Obviously, many modifications and variations of the present invention are possible in light of the above teachings. Thus, it is to be understood that, within the scope of the appended claims, the invention may be practiced otherwise than as specifically described above.

What is desired to be claimed in a Letters Patent of the United States is:

We claim:

1. A computerized method for creating a standardized as well as customized exchange traded and cleared structured financial product having a Fund Component and a listed Derivative Component, the method comprising the steps of:
(a) providing an investor with various selectable options for selecting the Fund Component from a plurality of asset classes;
(b) providing an investor with various selectable options for the exchange based listed Derivative Component from various asset classes for selecting an underlying asset to link to the Fund Component;
(c) providing an investor with various selectable options relating to a desired investment strategy; and
(d) computing a price for the exchange traded structured financial product or customizable structured financial product based upon the selected options for the Fund Component and the exchange traded and cleared Derivative Component based on the selected investment strategy.

2. The computerized method as recited in claim 1, wherein element (a) comprises:
(a) providing an investor with various selectable options for selecting the Fund Component from a plurality of asset classes, wherein the Fund Component includes at least one Fund which is combined with a Derivative Component and the overall return of the structured product is based upon the gain or loss of the Derivative Component and the Fund Component.

3. The computerized method as recited in claim 1, wherein step (a) further includes the step:
(e) receiving quotes and having a direct issuance program established with the primary issuers of the assets that comprise the Funds for the Fund Component for the selected options by the investor.

4. The computerized method as recited in claim 1, wherein step (a) further includes the step:
(e) purchasing assets in the open market for the Fund Component thus enabling diversification to reduce counterparty risk for the investor.

5. A computerized method for providing exchange traded structured financial products to investors on an exchange, the method comprising:
(a) creating standard structured financial products with fixed maturity dates based upon preselected options;
(b) enabling the structured financial products to be listed and traded on an Exchange;
(c) enabling the structured financial products to be cleared through an Exchange; and
(d) enabling the structured financial products to be settled through an Exchange.

6. A computerized method for providing exchange traded structures (ETS) to investors on an Exchange, the method comprising:
(a) creating standardized ETS products with fixed maturity dates based upon preselected options;
(b) determining the value of the ETS product on predetermined dates and rolling forward the maturity date by converting the ETS to a new ETS based upon the then value of the ETS thus extending the life of the original ETS;
(c) enabling the ETS to be listed and traded on an Exchange;
(d) enabling the ETS to be cleared through an Exchange; and
(e) enabling the ETS to be settled through an Exchange.

7. The method as recited in claim 5, further including the step of:
(f) listing the structured financial products on an Exchange periodically on a consistent calendar basis.

8. A method for creating or redeeming a structured financial product comprising the steps of:
(a) sending or receiving structured product securities and derivative contracts from a liquidity provider;
(b) determining the value of the structured financial product at the time of creation or redemption; and
(c) receiving or returning cash or an equivalent asset to the liquidity provider that reflects the value of the structured financial product at the time of redemption or creation.

9. A computerized method for charging fees in connection with the issuance of a structured product, the method comprising the step of:
(a) charging a fee that accretes daily over the term of the security.

10. A computerized method for standardized or customized structured financial products available by an alliance partner, the structured financial products having a Fund Component and a listed Derivative Component, the method comprising the steps of:
(a) providing an investor with various selectable options relating to standardized structured financial products;
(b) presenting the investors with available standard or customized structured financial products that satisfy the investors' selected options.
